(19) United States
(12) Patent Application Publication
(10) Pub. No.: US 2025/0198395 A1
(43) Pub. Date: Jun. 19, 2025

(54) APPARATUS TO CONVERT CENTRIFUGAL FORCE TO LINEAR MOTION

(71) Applicant: Mostafa Torkzaban, Malayer (IR)

(72) Inventor: Mostafa Torkzaban, Malayer (IR)

(21) Appl. No.: 18/790,715

(22) Filed: Jul. 31, 2024

Related U.S. Application Data
(63) Continuation-in-part of application No. PCT/IR2022/050005, filed on Jan. 31, 2022.

(51) Int. Cl. F03G 3/00; F16H 33/20

(52) U.S. Cl. CPC F03G 3/087; F16H 33/20

(57) ABSTRACT

In an example, a linear motion generation apparatus includes a power generation unit connected to a first shaft, a first cell and/or a linear motion generation device. The first shaft may allow a first hollow arm to rotate about a first rotation axis. The first cell may include a first set of plates and the first hollow arm. The first hollow arm may be connected to the first shaft. The first hollow arm may include one or more first metal covers connected to one or more first wheels. The one or more first metal covers may define a first arm chamber. The one or more first wheels may be in contact with the first set of plates. One or more first isolation layers inside the first arm chamber. The one or more first isolation layers may define a first fluid chamber to house a first fluid.

### RELATED APPLICATION

This application claims priority to and is a continuation-in-part of International Application Number PCT/IR2022/050005, filed on Jan. 31, 2022, entitled “LIQUID CLOSED SYSTEM TO CONVERT CENTRIFUGAL FORCE TO LINEAR FORCE”, which is incorporated by reference herein in its entirety.

### BACKGROUND

Aviation vehicles like airplanes and helicopters navigate the air using aerodynamic principles. Spacecrafts are engineered to travel beyond Earth's atmosphere. Nautical vehicles such as ships and submarines operate on or under water.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A illustrates a 3-dimensional front view of a linear motion generation apparatus, according to some embodiments.

FIG. 1B illustrates a 3-dimensional back view of a linear motion generation apparatus, according to some embodiments.

FIG. 1C illustrates a 3-dimensional front view of a linear motion generation apparatus, according to some embodiments.

FIG. 1D illustrates a 3-dimensional front view of a linear motion generation apparatus, according to some embodiments.

FIG. 1E illustrates a 3-dimensional front view of a linear motion generation apparatus, according to some embodiments.

FIG. 1F illustrates a 2-dimensional front view of a linear motion generation apparatus, according to some embodiments.

FIG. 2A illustrates an exploded view of a first set of hollow arms in a linear motion generation apparatus, according to some embodiments.

FIG. 2B illustrates a 3-dimensional view of a first hollow arm, according to some embodiments.

FIG. 2C illustrates a 2-dimensional side view of a first hollow arm, according to some embodiments.

FIG. 2D illustrates a 2-dimensional front view of a first hollow arm, according to some embodiments.

FIG. 2E illustrates a cross-sectional view of a first hollow arm, according to some embodiments.

FIG. 3A illustrates a 2-dimensional front view of a linear motion generation apparatus in neutral state, according to some embodiments.

FIG. 3B illustrates a 2-dimensional front view of a linear motion generation apparatus in upward force generation state, according to some embodiments.

FIG. 3C illustrates a 2-dimensional front view of a linear motion generation apparatus in downward force generation state, according to some embodiments.

FIG. 4 illustrates a 2-dimensional front view of a linear motion generation apparatus showing operation of a gearbox connected to aligned shafts in a linear motion generation apparatus in a neutral state, according to some embodiments.

FIG. 5A illustrates a 2-dimensional front view of a linear motion generation apparatus in upward force generation state, according to some embodiments.

FIG. 5B illustrates a 2-dimensional image of a 2-dimensional front view of a linear motion generation apparatus in upward force generation state at initial state of operation, according to some embodiments.

FIG. 5C illustrates a 2-dimensional image of a 2-dimensional front view of a linear motion generation apparatus in upward force generation state at second state of operation, according to some embodiments.

FIG. 5D illustrates a 2-dimensional image of a 2-dimensional front view of a linear motion generation apparatus in upward force generation state at third state of operation, according to some embodiments.

FIG. 5E illustrates a 2-dimensional image of a 2-dimensional front view of a linear motion generation apparatus in upward force generation state at fourth state of operation, according to some embodiments.

FIG. 5F illustrates a 2-dimensional image of a 2-dimensional front view of a linear motion generation apparatus in upward force generation state at final state of operation, according to some embodiments.

FIG. 6 illustrates a 2-dimensional front view of a linear motion generation apparatus in downward force generation state, according to some embodiments.

FIG. 7A illustrates a force steering system to obtain a desired force direction for a linear motion generation apparatus, according to some embodiments.

FIG. 7B illustrates an image of a linear motion generation apparatus mounted on a force steering device, according to some embodiments.

FIGS. 8A-8C illustrate a UFO-shaped vehicle, according to some embodiments.

FIGS. 9A-9D illustrate a UFO-shaped vehicle, according to some embodiments.

FIGS. 10A-10B illustrate an air-space bus, according to some embodiments.

FIG. 11 illustrates an image of a city with a lot of vehicles equipped with a plurality of linear motion generation apparatuses, according to some embodiments.

### DETAILED DESCRIPTION

The following subject matter may be embodied in a variety of different forms, such as methods, devices and/or systems. Accordingly, this subject matter is not intended to be construed as limited to any example embodiments set forth herein. Rather, example embodiments are provided merely to be illustrative.

All numerical values within the detailed description and the claims herein are modified by “about” or “approximately” the indicated value, and take into account experimental error and variations that would be expected by a person having ordinary skill in the art.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. Ranges from any lower limit to any upper limit are contemplated. The upper and lower limits of these smaller ranges which may independently be included in the smaller ranges are also encompassed within the disclosure, subject to any specifically excluded limit in the stated range. Where the stated range includes one or both of the limits, ranges excluding either both of those included limits are also included in the disclosure.

Although any methods and materials similar or equivalent to those described herein can also be used in the practice or testing of the present disclosure, the preferred methods and materials are now described. All publications mentioned herein are incorporated herein by reference to disclose and described the methods and/or materials in connection with which the publications are cited.

It must be noted that as used herein and in the appended claims, the singular forms “a”, “and”, and “the” include plural references unless the context clearly dictates otherwise.

Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure. All publications, patent applications, patents, figures and other references mentioned herein are expressly incorporated by reference in their entirety.

A linear motion generation apparatus may utilize a centrifugal force obtained from rotation of one or more hollow arms about one or more rotation axes to generate a linear force in a desired direction. Unlike the previous methods, utilizing a fluid (such as mercury) in the linear motion generation apparatus may change the weight of the one or more hollow arms. This method may have high efficiency without damage, without a lot of noises and/or may have the ability to increase the rotation speed. The centrifugal force may be obtained via below formula:

$$F = {mv}^{2} / r$$

Wherein m is a mass difference between the one or more hollow arms, vis an instantaneous linear velocity of the mass and r is a radius of the rotation of the one or more hollow arms. The instantaneous linear velocity may depend on an angular velocity of the one or more hollow arms.

In accordance with some embodiments of the present disclosure, a linear motion generation apparatus is provided. The linear motion generation apparatus may comprise a power generation unit connected to a first shaft, a first cell and/or a linear motion generation device. The first shaft may allow a first hollow arm to rotate about a first rotation axis. The first cell may comprise a first set of plates and the first hollow arm. The first hollow arm may be connected to the first shaft. The first hollow arm may comprise one or more first metal covers connected to one or more first wheels. The one or more first metal covers may define a first arm chamber. The one or more first wheels may be in contact with the first set of plates. One or more first isolation layers inside the first arm chamber. The one or more first isolation layers may define a first fluid chamber to house a first fluid.

In some examples, the linear motion generation apparatus is used to implement a vehicle. In some examples, the vehicle is an aerial vehicle, such as a Vertical Take-Off and Landing (VTOL) vehicle and/or other type of aerial vehicle. In some examples, the vehicle is a spacecraft for traveling through space. In some examples, the vehicle is a nautical vehicle for traveling through a body of water. For example, linear motion and/or other forces generated using the linear motion generation apparatus may be used to (i) move the vehicle (via a thrust force provided by the linear motion generation apparatus), (ii) lift the vehicle, (iii) keep the vehicle hovering and/or levitating in a target position, and/or (iv) perform one or more other operations.

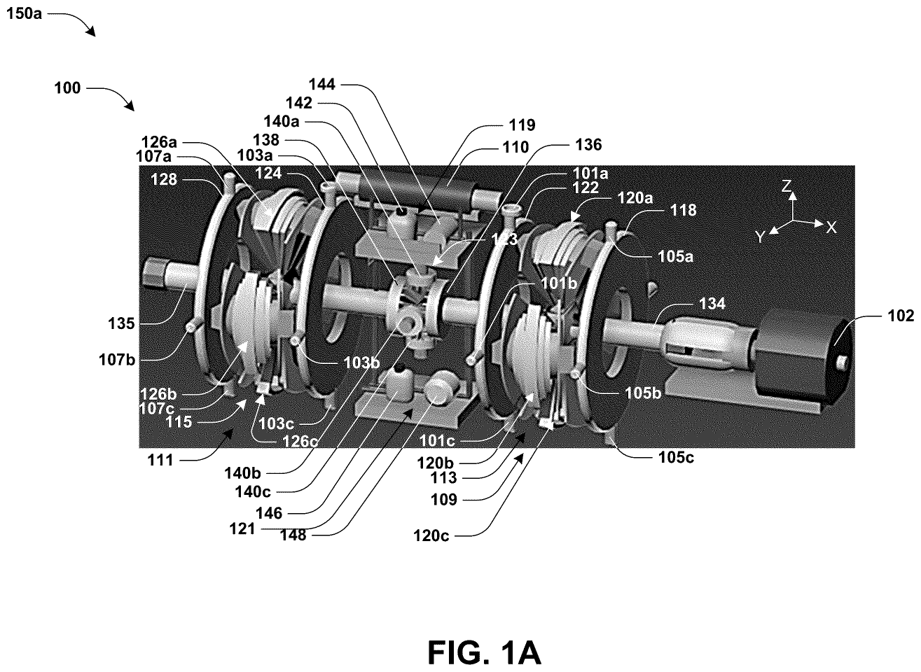

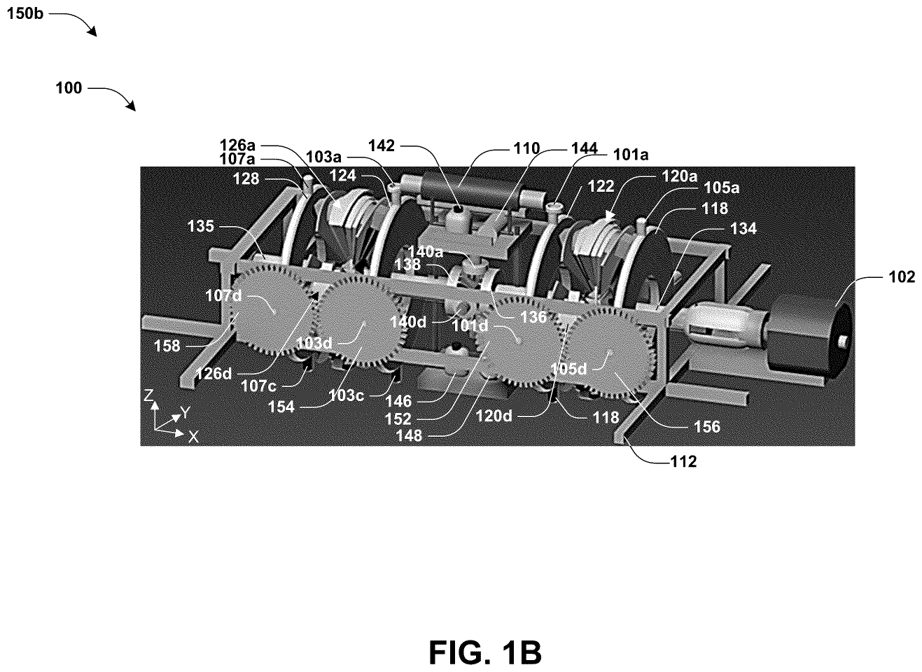

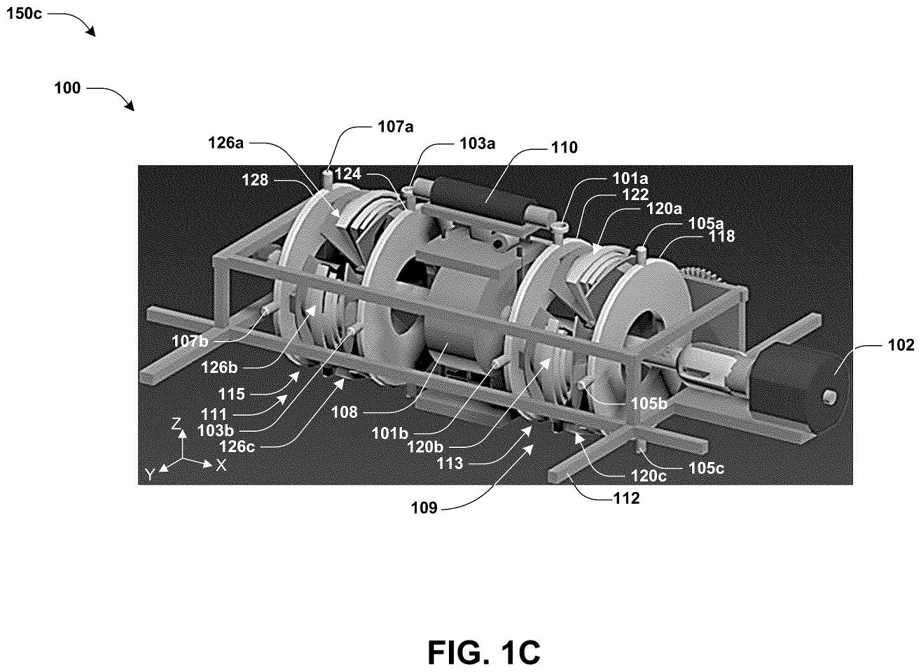

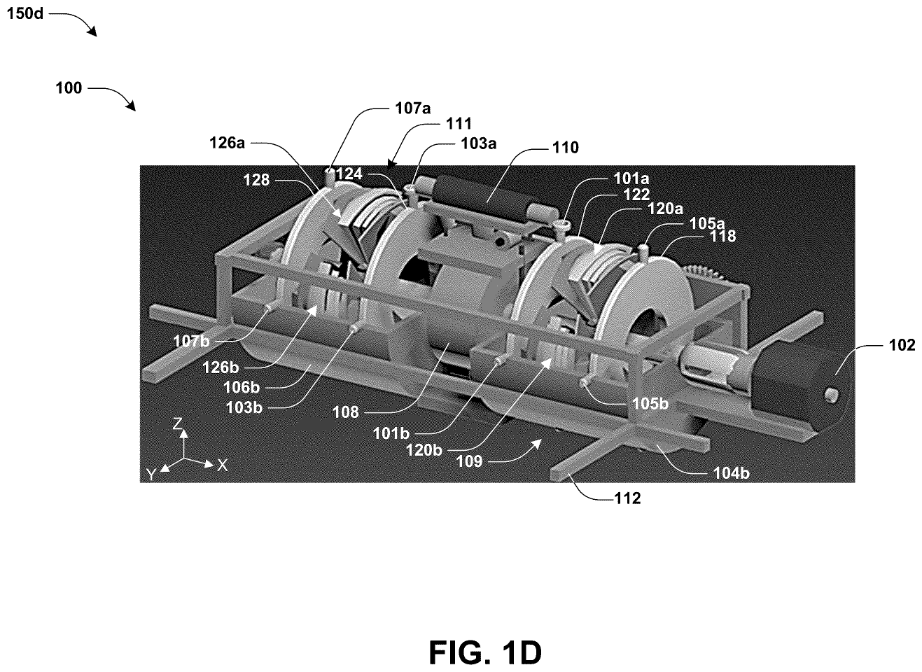

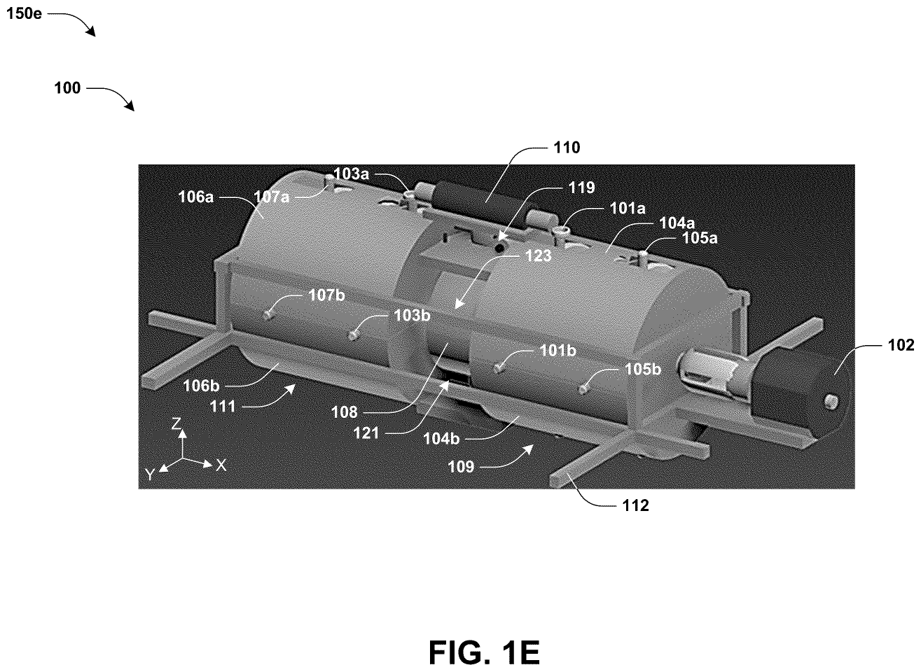

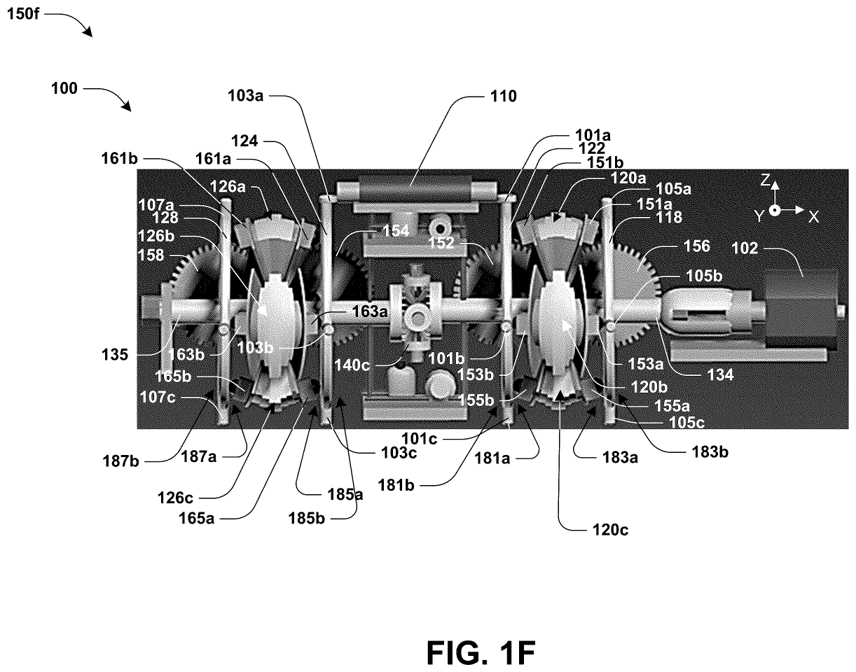

FIG. 1A illustrates a 3-dimensional front view 150a of the linear motion generation apparatus (shown with reference number 100), according to some embodiments. For simplicity and/or clarity, one or more components (e.g., top casing, bottom casing, chassis and/or gearbox casing) of the linear motion generation apparatus 100 may be removed from (and/or not depicted in) FIG. 1A. FIG. 1B illustrates a 3-dimensional back view 150b of the linear motion generation apparatus 100, according to some embodiments. For simplicity and/or clarity, one or more components (e.g., the top casing, the bottom casing, the chassis and/or the gearbox casing) of the linear motion generation apparatus 100 may be removed from (and/or not depicted in) FIG. 1B. The linear motion generation apparatus 100 may comprise a power generation unit 102 (e.g., an electromotor, a fossil fuel engine and/or a manual system comprising a handle that may be rotated by a human) configured to generate power (e.g., force) for a linear motion generation device. In some examples, the linear motion generation apparatus 100 may utilize one or more batteries (e.g., one or more rechargeable batteries) and/or one or more solar panels to provide power (e.g., electrical power) to the power generation unit 102. In some examples, the power generation unit 102 is connected to a first shaft 134. The first shaft 134 may allow a first set of hollow arms 113 (e.g., a first set of accordion-shaped arms) to rotate (e.g., to rotate clockwise and/or to rotate counterclockwise) about a first rotation axis (e.g., x-axis in xyz-coordination system (shown in FIGS. 1A-1B)).

In some examples, the linear motion generation apparatus 100 comprises the linear motion generation device. In some examples, the linear motion generation device comprises a first cell 109 and/or a second cell 111. In some examples, the first cell 109 comprises a first set of plates (e.g., a first plate 122 and/or a second plate 118). In some examples, the first plate 122 and/or the second plate 118 are able to rotate (e.g., to rotate clockwise and/or to rotate counterclockwise) about a rotation axis (e.g., y-axis in xyz-coordination system (shown in FIGS. 1A-1B)). In some examples, the second cell 111 comprises a second set of plates. The second set of plates may comprise a third plate 124 and/or a fourth plate 128. In some examples, the third plate 124 and/or the fourth plate 128 are able to rotate (e.g., to rotate clockwise and/or to rotate counterclockwise) about a rotation axis (e.g., y-axis in xyz-coordination system (shown in FIGS. 1A-1B)). In some examples, a direction of rotation of the first plate 122 is opposite to a direction of rotation of the second plate 118. In some examples, a direction of rotation of the third plate 124 is opposite to a direction of rotation of the fourth plate 128. In some examples, the direction of rotation of the first plate 122 is the same as the direction of rotation of the fourth plate 128. In some examples, the direction of rotation of the third plate 124 is the same as the direction of rotation of the second plate 118. In some examples, the first plate 122 is connected to one or more first rods (e.g., one or more first bolts). In some examples, the one or more first rods comprise a first rod 101a, a second rod 101b, a third rod 101c and/or a fourth rod 101d. In some examples, the second plate 118 is connected to one or more second rods (e.g., one or more second bolts). In some examples, the one or more second rods comprise a fifth rod 105a, a sixth rod 105b, a seventh rod 105c and/or an eighth rod 105d. In some examples, the third plate 124 is connected to one or more third rods (e.g., one or more third bolts). In some examples, the third plate 124 comprises a ninth rod 103a, a tenth rod 103b, an eleventh rod 103c and/or a twelfth rod 103d. In some examples, the third plate 124 is connected to one or more fourth rods (e.g., one or more fourth bolts). In some examples, the fourth plate 128 comprises a thirteenth rod 107a, a fourteenth rod 107b, a fifteenth rod 107c and/or a sixteenth rod 107d. Although FIGS. 1A-1B show four rods for each plate, any number of rods (e.g., any number of rods for a given plate) are contemplated in the present disclosure.

In some examples, the first cell 109 comprises the first set of hollow arms 113. The first set of hollow arms 113 may comprise a first hollow arm 120a, a second hollow arm 120b, a third hollow arm 120c and/or a fourth hollow arm 120d. In some examples, the first set of hollow arms 113 are between the first plate 122 and the second plate 118. Although FIGS. 1A-1B show four hollow arms for the first cell 109, any number of hollow arms are contemplated in the present disclosure. In some examples, the first set of hollow arms 113 are connected to the first shaft 134. In some examples, the first set of hollow arms 113 are connected to the first shaft 134 coaxially (e.g., such that an axis of rotation of a hollow arm of the first set of hollow arms 113 is parallel to and/or the same as an axis of rotation of the first shaft 134). In some examples, the first set of hollow arms 113 comprise one or more first metal covers (e.g., one or more first accordion-shaped covers and/or one or more first foldable covers). In some examples, the one or more first metal covers are connected to one or more first wheels (e.g., one or more first rollers, one or more first bearings and/or etc.). In some examples, one or more wheels (e.g., a first wheel) of the one or more first wheels are in contact with a first surface of the first plate 122. In some examples, one or more wheels (e.g., a second wheel) of the one or more first wheels are in contact with a second surface of the second plate 118. In some examples, the first surface of the first plate 122 is tapered (e.g., tilted, angled) to have a first slope (e.g., a first angle) and/or the second surface of the second plate 118 is tapered to have a second slope (e.g., a second angle). In some examples, the first slope is opposite in polarity to the second slope. In some examples, the one or more first metal covers define one or more first arm chambers. In some examples, the one or more first arm chambers comprise a first arm chamber, a second arm chamber, a third arm chamber and/or a fourth arm chamber. In some examples, the first set of hollow arms 113 comprise one or more first isolation layers (e.g., one or more first rubber layers). In some examples, the one or more first isolation layers comprise a first isolation layer, a second isolation layer, a third isolation layer and/or a fourth isolation layer. In some examples, the one or more first isolation layers define one or more first fluid chambers. In some examples, the one or more first fluid chambers comprise the first fluid chamber, a second fluid chamber, a third fluid chamber and/or a fourth fluid chamber. In some examples, the first isolation layer is inside the first arm chamber. In some examples, the second isolation layer is inside the second arm chamber. In some examples, the third isolation layer is inside the third arm chamber. In some examples, the fourth isolation layer is inside the fourth arm chamber. In some examples, the one or more first fluid chambers comprise the first fluid (e.g., a metal and/or a mixed fluid). In some examples, the first fluid is inside the first isolation layer, the second isolation layer, the third isolation layer and/or the fourth isolation layer. The first fluid may comprise a metal and/or a mixed fluid. The metal may comprise a liquid metal (e.g., Mercury (Hg)). The mixed fluid may comprise ethylene dibromide (EDB); Cis-1,2-Dibromoethene; Trans-1,2-Dibromoethene; Dibromomethane; Bromal; Bromoform; 1,1,2,2-Tetrabromoethane (Muthmanns solution); Sodium polytungstate; Bromine; Thoulets solution; Diiodomethane; Indium (III) iodide; Barium tetraiodomercurate (II); Thallium formate+thallium malonate (Clerici solution); Galinstan (gallium, indium, tin alloy); and/or Mercury. In some examples, the first fluid is a heavy liquid with high density (e.g., with density more than 2.0 grams per cubic centimeter). In some examples, the first fluid is a liquid, a gas, a plasma and/or a suspension solution.

In some examples, the second cell 111 comprises a second set of hollow arms 115. The second set of hollow arms 115 may comprise a fifth hollow arm 126a, a sixth hollow arm 126b, a seventh hollow arm 126c and/or an eighth hollow arm 126d. In some examples, the second set of hollow arms 115 are between the third plate 124 and the fourth plate 128. Although FIGS. 1A-1B show four hollow arms for the second cell 111, any number of hollow arms are contemplated in the present disclosure. In some examples, the second set of hollow arms 115 are connected to a second shaft 135. In some examples, the second set of hollow arms 115 are connected to the second shaft 135 coaxially (e.g., such that an axis of rotation of a hollow arm of the second set of hollow arms 115 is parallel to and/or the same as an axis of rotation of the second shaft 135). In some examples, the second set of hollow arms 115 comprise one or more second metal covers (e.g., one or more second accordion-shaped covers and/or one or more second foldable covers). In some examples, the one or more second metal covers are connected to one or more second wheels (e.g., one or more second rollers, one or more second bearings and/or etc.). In some examples, one or more wheels (e.g., a first wheel) of the one or more second wheels are in contact with a first surface of the third plate 124. In some examples, one or more wheels (e.g., a second wheel) of the one or more second wheels are in contact with a second surface of the fourth plate 128. In some examples, the first surface of the third plate 124 is tapered (e.g., tilted, angled) to have a third slope (e.g., a third angle) and/or the second surface of the fourth plate 128 is tapered to have a fourth slope (e.g., a fourth angle). In some examples, the third slope is opposite in polarity to the fourth slope. In some examples, the one or more second metal covers define one or more second arm chambers. In some examples, the one or more second arm chambers comprise a fifth arm chamber, a sixth arm chamber, a seventh arm chamber and/or an eighth arm chamber. In some examples, the second set of hollow arms 115 comprise one or more second isolation layers (e.g., one or more second rubber layers). In some examples, the one or more second isolation layers comprise a fifth isolation layer, a sixth isolation layer, a seventh isolation layer and/or an eighth isolation layer. In some examples, the one or more second isolation layers define one or more second fluid chambers. In some examples, the one or more second fluid chambers comprise a fifth fluid chamber, a sixth fluid chamber, a seventh fluid chamber and/or an eighth fluid chamber. In some examples, the fifth isolation layer is inside the fifth arm chamber. In some examples, the sixth isolation layer is inside the sixth arm chamber. In some examples, the seventh isolation layer is inside the seventh arm chamber. In some examples, the eighth isolation layer is inside the eighth arm chamber.

In some examples, the one or more second fluid chambers comprise a second fluid (e.g., a metal and/or a mixed fluid). In some examples, the second fluid is inside the fifth isolation layer, the sixth isolation layer, the seventh isolation layer and/or the eighth isolation layer. The second fluid may comprise a metal and/or a mixed fluid. The metal may comprise a liquid metal (e.g., Mercury (Hg)). The mixed fluid may comprise ethylene dibromide (EDB); Cis-1,2-Dibromoethene; Trans-1,2-Dibromoethene; Dibromomethane; Bromal; Bromoform; 1,1,2,2-Tetrabromoethane (Muthmanns solution); Sodium polytungstate; Bromine; Thoulets solution; Diiodomethane; Indium (III) iodide; Barium tetraiodomercurate (II); Thallium formate+thallium malonate (Clerici solution); Galinstan (gallium, indium, tin alloy); and/or Mercury. In some examples, the first fluid is a heavy liquid with high density (e.g., with density more than 2.0 grams per cubic centimeter). In some examples, the first fluid is a liquid, a gas, a plasma and/or a suspension solution.

In some examples, the linear motion generation apparatus 100 comprises a gearbox 123. In some examples, the gearbox 123 comprises a first gear 136, a second gear 138, a third gear 140a, a fourth gear 140b, a fifth gear 140c and/or a sixth gear 140d. The gearbox 123 may be connected to a gearbox lubrication system 121 via one or more lubrication tubes (e.g., one or more lubrication hoses). The gearbox lubrication system 121 may be configured to lubricate the gearbox 123. In some examples, the gearbox lubrication system 121 lubricates the other parts of the linear motion generation apparatus 100. In some examples, the gearbox lubrication system 121 comprises an oil tank 146, a plurality of tubes and/or an oil pump 148. The oil pump 148 may pump the oil inside the oil tank 146 into the gearbox 123.

In some examples, the linear motion generation apparatus 100 comprises a plurality of tilting gears. In some examples, the plurality of the tilting gears comprise a first tilting gear 152, a second tilting gear 156, a third tilting gear 154 and/or a fourth tilting gear 158. In some examples, center of the first tilting gear 152 is in contact with (e.g., attached to) the fourth rod 101d, center of the second tilting gear 156 is in contact with the eighth rod 105d, center of the third tilting gear 154 and center of the fourth tilting gear 158 is in contact with the sixteenth rod 107d. In some examples, the first tilting gear 152 is in contact with (e.g., engaged with) the second tilting gear 156 and/or the third tilting gear 154 is in contact with the fourth tilting gear 158.

In some examples, the linear motion generation apparatus 100 comprises the first shaft 134 wherein the first shaft 134 is connected to the power generation unit 102 from one side and/or to the first gear 136 from the other side. In some examples, the linear motion generation apparatus 100 comprises the second shaft 135 wherein the second shaft 135 is connected to the casing and/or to the chassis from one side and/or the second shaft 135 is connected to the second gear 138 from the other side. In some examples, the second shaft 135 is connected to the casing and/or to the chassis via a bearing (e.g., a ball bearing, a roller bearing, etc.). In some examples, the first gear 136 is in contact with (e.g., engaged with) the third gear 140a, the fourth gear 140b, the fifth gear 140c and/or the sixth gear 140d. In some examples, the second gear 138 is in contact with (e.g., engaged with) the third gear 140a, the fourth gear 140b, the fifth gear 140c and/or the sixth gear 140d. In some examples, the third gear 140a, the fourth gear 140b, the fifth gear 140c and/or the sixth gear 140d are mounted (e.g., embedded) on the gearbox casing. In some examples, a direction of rotation of the first shaft 134 is opposite to a direction of rotation of the second shaft 135. In some examples, a direction of rotation of the first gear 136 is opposite to a direction of rotation of the second gear 138. In some examples, the gearbox 123 causes the direction of rotation of the second shaft 135 to be opposite to the direction of rotation of the first shaft 134.

In some examples, the linear motion generation apparatus 100 comprises a hydraulic jack 110 (e.g., a pneumatic jack, a manual jack comprising a handle that is operated by a human, etc.) configured to apply power (e.g., force) to one or more rods (e.g., the first rod 101a) of the one or more first rods and/or to apply power (e.g., force) to one or more rods (e.g., the ninth rod 103a) of the one or more third rods. In some examples, the hydraulic jack 110 is connected to a hydraulic jack lubrication system 119 via one or more lubrication tubes (e.g., lubrication hoses). The hydraulic jack lubrication system 119 may be configured to lubricate the hydraulic jack 110. In some examples, the hydraulic jack lubrication system 119 lubricates the other parts of the linear motion generation apparatus 100. In some examples, the hydraulic jack lubrication system 119 comprises an oil tank 142, a plurality of tubes and/or an oil pump 144. The oil pump 144 may pump the oil inside the oil tank 142 into the hydraulic jack 110.

FIG. 1C illustrates a 3-dimensional front view 150c of the linear motion generation apparatus 100, according to some embodiments. For simplicity and/or clarity, one or more components (e.g., the top casing and/or the bottom casing) of the linear motion generation apparatus 100 may be removed from (and/or not depicted in) FIG. 1C. In some examples, the linear motion generation apparatus 100 comprises the chassis (shown with reference number 112) configured to hold (e.g., to protect, to cover, to support and/or etc.) the linear motion generation device. In some examples, the chassis 112 defines a chassis chamber in order to hold other parts of the linear motion generation apparatus 100. In some examples, the linear motion generation apparatus 100 comprises the gearbox casing (shown with reference number 108) configured to hold (e.g., to protect, to cover, to support and/or etc.) the gearbox 123.

FIG. 1D illustrates a 3-dimensional front view 150d of the linear motion generation apparatus 100, according to some embodiments. For simplicity and/or clarity, one or more components (e.g., the top casing) of the linear motion generation apparatus 100 may be removed from (and/or not depicted in) FIG. 1D. FIG. 1E illustrates a 3-dimensional front view 150e of the linear motion generation apparatus 100, according to some embodiments. In some examples, the linear motion generation apparatus 100 comprises a casing (e.g., a shell, a cover, etc.) configured to hold (e.g., to protect, to cover, to support and/or etc.) the linear motion generation device. In some examples, the casing comprises a first casing configured to cover at least a portion of the first cell 109 and/or a second casing configured to cover at least a portion of the second cell 111. In some examples, the first casing comprises a first top casing 104a and/or a first bottom casing 104b. In some examples, the second casing comprises a second top casing 106a and/or a second bottom casing 106b. In some examples, the first casing comprises one or more first holes (e.g., one or more first trenches, etc.) and/or one or more second holes (e.g., one or more second trenches, etc.) configured to embed (e.g., to house, hold, etc.) one or more rods of the one or more first rods and/or to embed one or more rods of the one or more second rods. In some examples, the second casing comprises one or more third holes (e.g., one or more third trenches, etc.) and/or one or more fourth rods (e.g., one or more fourth trenches, etc.) configured to embed (e.g., to house, hold, etc.) one or more rods of the one or more third rods and/or to embed one or more rods of the one or more fourth rods. In some examples, the linear motion generation apparatus 100 comprises the top casing and/or the bottom casing. In some examples, the top casing comprises the first top casing 104a and/or the second top casing 106a. In some examples, the bottom casing comprises the first bottom casing 104b and/or the second bottom casing 106b.

FIG. 1F illustrates a 2-dimensional front view 150f of the linear motion generation apparatus 100, according to some embodiments. For simplicity and/or clarity, one or more components (e.g., the top casing, the bottom casing, the chassis 112 and/or the gearbox casing 108) of the linear motion generation apparatus 100 may be removed from (and/or not depicted in) FIG. 1F. In some examples, the top casing comprises the first top casing 104a and/or the second top casing 106a. In some examples, the bottom casing comprise the first bottom casing 104b and/or the second bottom casing 106b. In some examples, the first hollow arm 120a comprises a wheel 151a and/or a wheel 151b, the second hollow arm 120b comprises a wheel 153a and/or a wheel 153b, the third hollow arm 120c comprises a wheel 155a and/or a wheel 155b, and/or the fourth hollow arm 120d comprises a first wheel and a second wheel (not shown) similar to the other hollow arms. In some examples, the fifth hollow arm 126a comprises a wheel 161a and/or a wheel 161b, the sixth hollow arm 126b comprises a wheel 163a and/or a wheel 163b, the seventh hollow arm 126c comprises a wheel 165a and/or a wheel 165b, and/or the eighth hollow arm 126d comprises a first wheel and a second wheel (not shown) similar to the other hollow arms. In some examples, the first plate 122 comprises a first surface 181a and a second surface 181b. In some examples, the second plate 118 comprises a second surface 183a and a first surface 183b. In some examples, the third plate 124 comprises a first surface 185a and a second surface 185b. In some examples, the fourth plate 128 comprises a second surface 187a and a first surface 187b. In some examples, the first surface 181a of the first plate 122 and the second surface 183a of the second plate 118 are facing each other. In some examples, the first surface 185a of the third plate 124 and the second surface 187a of the fourth plate 128 are facing each other. In some examples, the wheels 151b, 153b, 155b and/or the second wheel of the fourth hollow arm 120d are in contact with and/or rotates on the first surface 181a. In some examples, the wheels 151a, 153a, 155a and/or the first wheel of the fourth hollow arm 120d are in contact with and/or rotates on the second surface 183a. In some examples, the wheels 161a, 163a, 165a and/or the first wheel of the eighth hollow arm 126d are in contact with and/or rotates on the first surface 185a. In some examples, the wheels 161b, 163b, 165b and/or the second wheel of the eighth hollow arm 126d are in contact with and/or rotates on the second surface 187a.

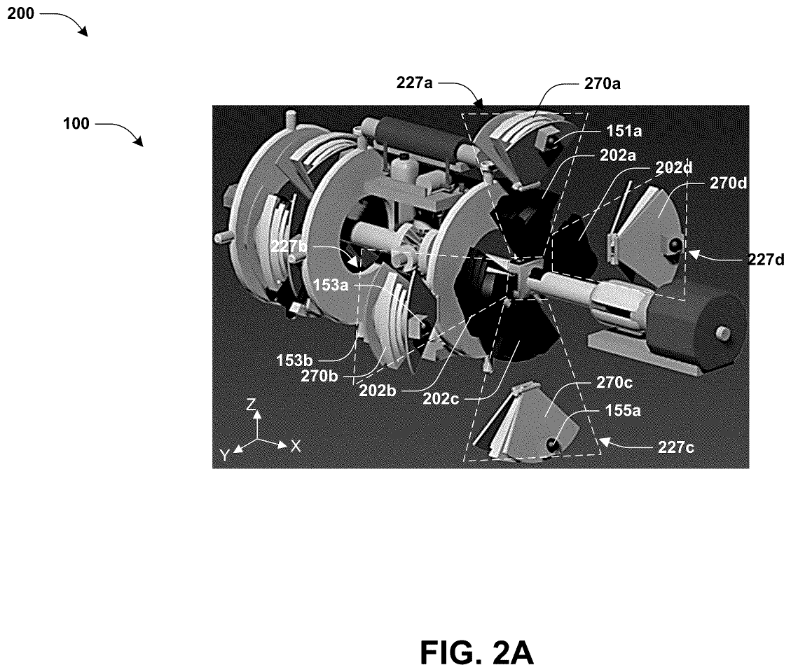

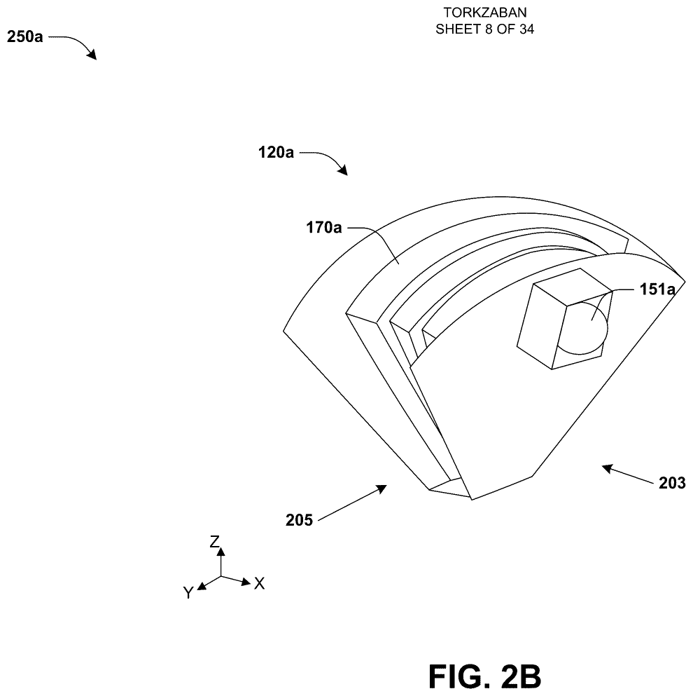

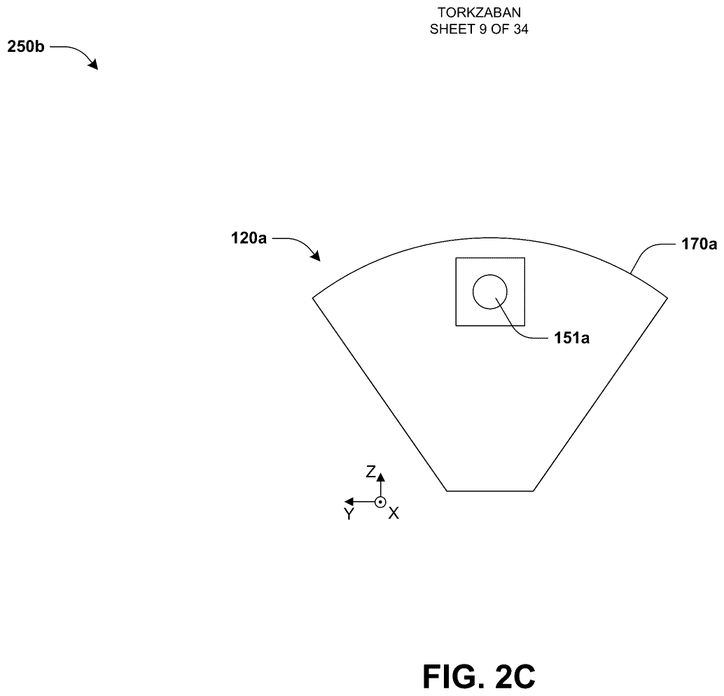

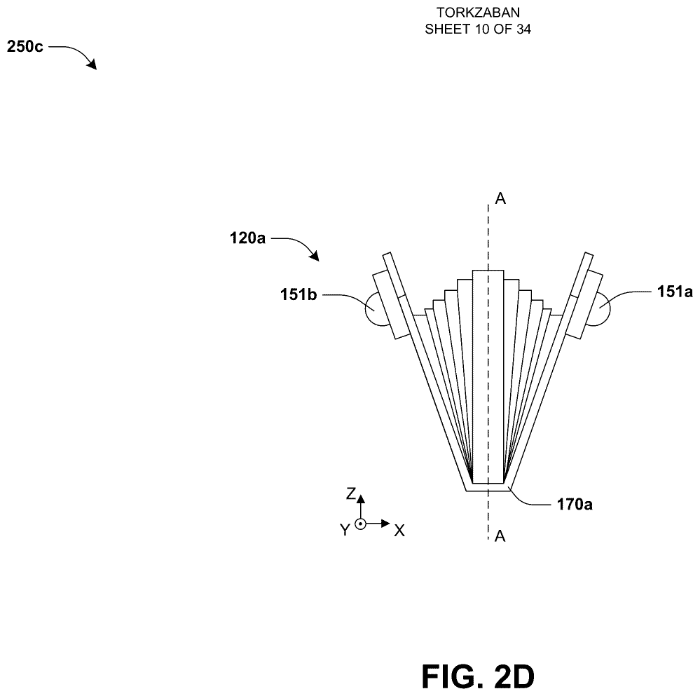

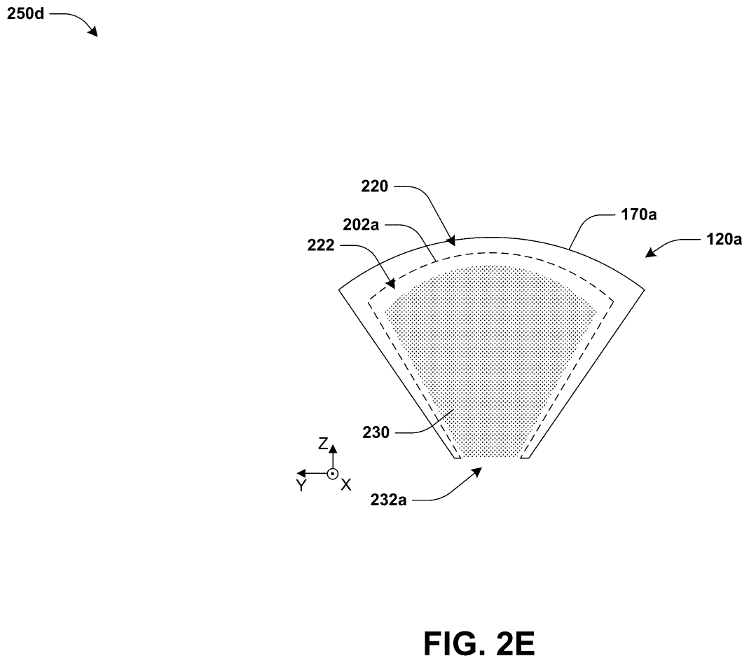

FIG. 2A illustrates an exploded view 200 of the first set of hollow arms 113 in the linear motion generation apparatus 100, according to some embodiments. With respect to FIGS. 1A-1F and/or FIG. 2A, the first set of hollow arms 113 may comprise the first hollow arm 120a, the second hollow arm 120b, the third hollow arm 120c and/or the fourth hollow arm 120d. In some examples, the first set of hollow arms 113 comprise the one or more first metal covers. In some examples, the first set of hollow arms 113 comprise the one or more first isolation layers. In some examples, the one or more first metal covers comprise a first metal cover 170a, a second metal cover 170b, a third metal cover 170c and/or a fourth metal cover 170d. In some examples, the one or more first isolation layers comprise a first isolation layer 202a, a second isolation layer 202b, a third isolation layer 202c and/or a fourth isolation layer 202d. In FIG. 2A, a first exploded view 227a shows different parts of the first hollow arm 120a, a second exploded view 227b shows different parts of the second hollow arm 120b, a third exploded view 227c shows different parts of the third hollow arm 120c and/or a fourth exploded view 227d shows different parts of the fourth hollow arm 120d. With respect to FIGS. 1A-1F and/or FIG. 2A, the second set of hollow arms 115 may comprise the fifth hollow arm 126a, the sixth hollow arm 126b, the seventh hollow arm 126c and/or the eighth hollow arm 126d. In some examples, the second set of hollow arms 115 comprise the one or more second metal covers. In some examples, the second set of hollow arms 115 comprise the one or more second isolation layers. In some examples, the one or more second metal covers comprise four metal covers same as the one or more first metal covers. In some examples, the one or more second isolation layers comprise four isolation layers same as the one or more first isolation layers. In some examples, the one or more second metal covers comprise a fifth metal cover, a sixth metal cover, a seventh metal cover and/or an eighth metal cover. In some examples, the one or more second isolation layers comprise the fifth isolation layer, the sixth isolation layer, the seventh isolation layer and/or the eighth isolation layer. Although FIGS. 1A-1B and FIG. 2A show four isolation layers and/or four metal covers for the first cell 109 and/or the second cell 111, any number of isolation layers and/or metal covers are contemplated in the present disclosure.

FIG. 2B illustrates a 3-dimensional view 250a of the first hollow arm 120a, according to some embodiments. In some examples, the first hollow arm 120a comprises the first metal cover 170a, the first isolation layer 202a, the wheel 151a and/or the wheel 151b (shown in FIG. 1F). As shown in FIG. 2B, a direction 203 (e.g., a direction parallel to x-axis of xyz-coordination system shown in FIG. 2B) is side view of the first hollow arm 120a and a direction 205 (e.g., a direction parallel to y-axis of xyz-coordination system shown in FIG. 2B) is front view of the first hollow arm 120a.

FIG. 2C illustrates a 2-dimensional side view 250b of the first hollow arm 120a (such that an observer looks from the direction 203 to the first hollow arm 120a), according to some embodiments.

FIG. 2D illustrates a 2-dimensional front view 250c of the first hollow arm 120a (such that an observer looks from the direction 205 to the first hollow arm 120a), according to some embodiments.

FIG. 2E illustrates a cross-sectional view 250d (e.g., a side view of section A-A, from the direction 203) of the first hollow arm 120a, according to some embodiments. In FIG. 2E, the cross-sectional view 250d is a view of section A-A (shown in FIG. 2D) of the first hollow arm 120a. In some examples, the first hollow arm 120a comprises the first metal cover 170a, the first arm chamber (shown with reference number 220), the first isolation layer 202a, the first fluid chamber (shown with reference number 222), the first fluid (shown with reference number 230) and/or a first opening 232a (e.g., a first hole, a first aperture, etc.). In some examples, the first metal cover 170a comprises at least a portion of the first opening 232a. In some examples, the first isolation layer 202a comprises at least a portion of the first opening 232a. In some examples, the second hollow arm 120b comprises the second metal cover 170b, the second arm chamber (not shown), the second isolation layer 202b, the second fluid chamber (not shown), the first fluid 230 and/or a second opening (e.g., a second hole, a second aperture, etc.). in some examples, the second metal cover 170b comprises at least a portion of the second opening. In some examples, the second isolation layer 202b comprises at least a portion of the second opening. In some examples, the third hollow arm 120c comprises the third metal cover 170c, the third arm chamber (not shown), the third isolation layer 202c, the third fluid chamber (not shown), the first fluid 230 and/or a third opening (e.g., a third hole, a third aperture, etc.). In some examples, the third metal cover 170c comprises at least a portion of the third opening. In some examples, the third isolation layer 202c comprises at least a portion of the third opening. In some examples, the fourth hollow arm 120d comprises the fourth metal cover 170d, the fourth arm chamber (not shown), the fourth isolation layer 202d, the fourth fluid chamber (not shown), the first fluid 230 and/or a fourth opening (e.g., a fourth hole, a fourth aperture, etc.). In some examples, the fourth metal cover 170d comprises at least a portion of the fourth opening. In some examples, the fourth isolation layer 202d comprises at least a portion of the fourth opening. In some examples, the fifth hollow arm 126a comprises the fifth metal cover, the fifth arm chamber, the fifth isolation layer, the fifth fluid chamber, the second fluid and/or a fifth opening (e.g., a fifth hole, a fifth aperture, etc.). in some examples, the fifth metal cover comprises at least a portion of the fifth opening. In some examples, the fifth isolation layer comprises at least a portion of the fifth opening. In some examples, the sixth hollow arm 126b comprises the sixth metal cover, the sixth arm chamber, the sixth isolation layer, the sixth fluid chamber, the second fluid and/or a sixth opening (e.g., a sixth hole, a sixth aperture, etc.). in some examples, the sixth metal cover comprises at least a portion of the sixth opening. In some examples, the sixth isolation layer comprises at least a portion of the sixth opening. In some examples, the seventh hollow arm 126c comprises the seventh metal cover, the seventh arm chamber, the seventh isolation layer, the seventh fluid chamber, the second fluid and/or a seventh opening (e.g., a seventh hole, a seventh aperture, etc.). in some examples, the seventh metal cover comprises at least a portion of the seventh opening. In some examples, the seventh isolation layer comprises at least a portion of the seventh opening. In some examples, the eighth hollow arm 126d comprises the eighth metal cover, the eighth arm chamber, the eighth isolation layer, the eighth fluid chamber, the second fluid and/or an eighth opening (e.g., an eighth hole, an eighth aperture, etc.). In some examples, the eighth metal cover comprises at least a portion of the eighth opening. In some examples, the eighth isolation layer comprises at least a portion of the eighth opening. In some examples, the first opening 232a is in contact with the second opening, the third opening and/or the fourth opening. The first fluid 230 may flow between the first isolation layer 202a, the second isolation layer 202b, the third isolation layer 202c and/or the fourth isolation layer 202d. In some examples, the first fluid 230 exits from and/or enters (i) the first isolation layer 202a via the first opening 232a, (ii) the second isolation layer 202b via the second opening, (iii) the third isolation layer 202c via the third opening, and/or (iv) the fourth isolation layer 202d via the fourth opening. In some examples, the fifth opening is in contact with the sixth opening, the seventh opening and/or the eighth opening. The second fluid may flow between the fifth isolation layer, the sixth isolation layer, the seventh isolation layer and/or the eighth isolation layer. In some examples, the second fluid exits from and/or enters (i) the fifth isolation layer via the fifth opening, (ii) the sixth isolation layer via the sixth opening, (iii) the seventh isolation layer via the seventh opening, and/or (iv) the eighth isolation layer via the eighth opening.

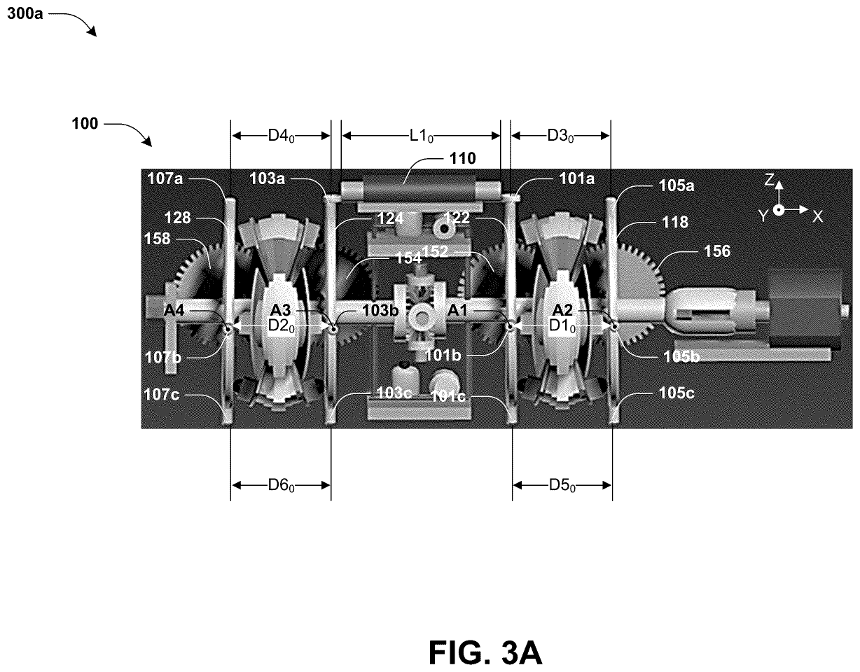

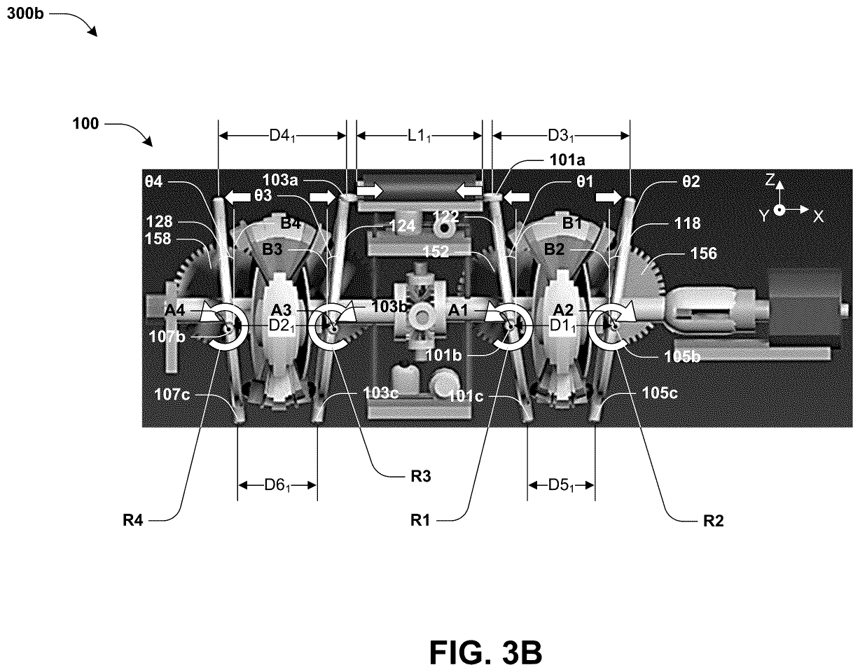

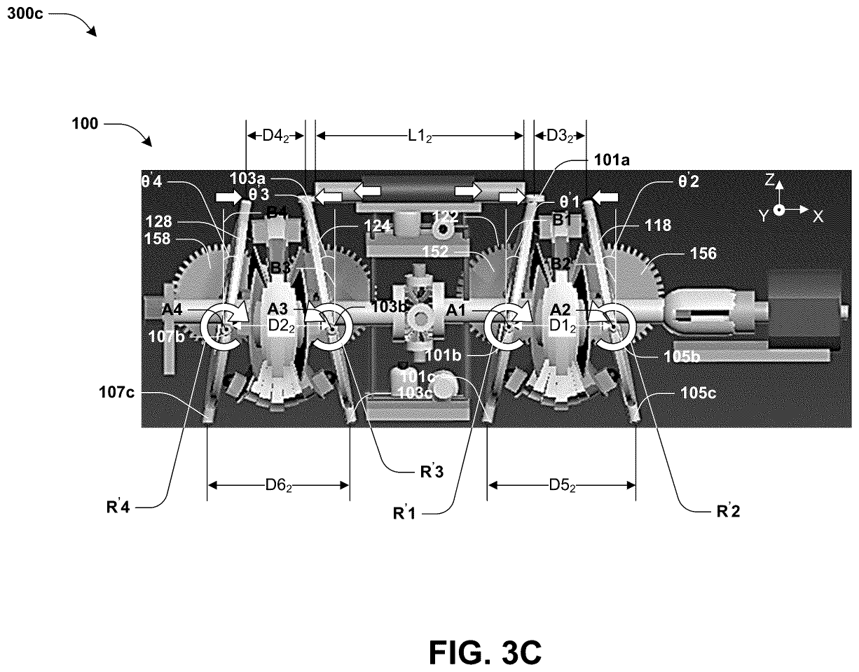

FIG. 3A illustrates a 2-dimensional front view 300a of the linear motion generation apparatus 100 in neutral state, according to some embodiments. With respect to FIG. 3A, distance D1₀ is a first distance between the second rod 101b and the sixth rod 105b, distance D2₀ is a first distance between the tenth rod 103b and the fourteenth rod 107b, length L1₀ is the first length of the hydraulic jack 110, distance D3₀ is a first distance between the first rod 101a and the fifth rod 105a, distance D4₀ is a first distance between the ninth rod 103a and the thirteenth rod 107a, distance D5₀ is a first distance between the third rod 101c and the seventh rod 105c and distance D6₀ is a first distance between the eleventh rod 103c and the fifteenth rod 107c. Axis A1 is an axis (e.g., an axis parallel to y-axis of xyz-coordination system) from center of the second rod 101b to center of the fourth rod 101d, axis A2 is an axis (e.g., an axis parallel to A1) from center of the sixth rod 105b to center of the eighth rod 105d, axis A3 is an axis (e.g., an axis parallel to the axes A1 and/or A2) from center of the sixth rod 105b to center of the eighth rod 105d and axis A4 is an axis (e.g., an axis parallel to the axes A1, A2 and/or A3).

FIG. 3B illustrates a 2-dimensional front view 300b of the linear motion generation apparatus 100 in upward force generation state, according to some embodiments. In an example, the length L1₀ (e.g., the first length of the hydraulic jack 110) may be reduced to second length L1₁. For example, the reduction of the length L1₀ to the second length L1₁ may cause rotation R1 of the first plate 122 about an axis A1 (e.g., an axis parallel to y-axis). Alternatively and/or additionally, the rotation R1 of the first plate 122 may cause the same rotation R1 of the first tilting gear 152 about the axis A1. Alternatively and/or additionally, the rotation R1 of the first tilting gear 152 may cause rotation R2 of the second tilting gear 156 about an axis A2 (e.g., an axis parallel to A1). Alternatively and/or additionally, the rotation R2 of the second tilting gear 156 may cause the same rotation R2 of the second plate 118 about the axis A2. For example, the reduction of the length L1₀ to the second length L1₁ may cause rotation R3 of the third plate 124 about an axis A3 (e.g., an axis parallel to y-axis). Alternatively and/or additionally, the rotation R3 of the third plate 124 may cause the same rotation R3 of the third tilting gear 154 about the axis A3. Alternatively and/or additionally, the rotation R3 of the third tilting gear 154 may cause rotation R4 of the fourth tilting gear 158 about an axis A4 (e.g., an axis parallel to A3). Alternatively and/or additionally, the rotation R4 of the fourth tilting gear 158 may cause the same rotation R4 of the fourth plate 128 about the axis A4. In some examples, after the rotation R1 of the first plate 122 about the first axis A1, the first plate 122 may comprise a first slope θ1 wherein the first slope θ1 is an angle between the first plate 122 and a line B1 (e.g., a line parallel to the z-axis). In some examples, after the rotation R2 of the second plate 118 about the second axis A2, the second plate 118 may comprise a second slope θ2 wherein the second slope θ2 is an angle between the second plate 118 and a line B2 (e.g., a line parallel to the line B1). In some examples, after the rotation R3 of the third plate 124 about the third axis A3, the third plate 124 may comprise a third slope θ3 wherein the third slope θ3 is an angle between the third plate 124 and a line B3 (e.g., a line parallel to the line B2). In some examples, after the rotation R4 of the fourth plate 128 about the fourth axis A4, the fourth plate 128 may comprise a fourth slope θ4 wherein the fourth 1 slope θ4 is an angle between the fourth plate 128 and a line B4 (e.g., a line parallel to the line B3). In some examples, the first slope θ1 may be equal and/or opposite in polarity to the second slope θ2. In some examples, the third slope θ3 may be equal and/or opposite in polarity to the fourth slope θ4. In some examples, the first slope θ1 may be the same as the fourth slope θ4. In some examples, the second slope θ2 may be the same as the third slope θ3. In some examples, after the rotations R1, R2, R3 and/or R4, the distance D4₀ and/or the distance D3₀ may increase to the distance D4₁ and/or the distance D3₁ respectively. Alternatively and/or additionally, the distance D6₀ and/or the distance D5₀ may decreases to the distance D6₁ and/or the distance D5₁. In some examples, the distance D1₀ is equal to the distance D1₁ and/or the distance D2₀ is equal to the distance D2₁.

FIG. 3C illustrates a 2-dimensional front view 300c of the linear motion generation apparatus 100 in downward force generation state, according to some embodiments. In an example, the length L1₀ (e.g., the first length of the hydraulic jack 110) may be enlarged to third length L12. For example, the enlargement of the length L1₀ to the third length L12 may cause rotation R′1 of the first plate 122 about the axis A1 (e.g., an axis parallel to y-axis). Alternatively and/or additionally, the rotation R′1 of the first plate 122 may cause the same rotation R′1 of the first tilting gear 152 about the axis A1. Alternatively and/or additionally, the rotation R′1 of the first tilting gear 152 may cause rotation R′2 of the second tilting gear 156 about the axis A2 (e.g., an axis parallel to A1). Alternatively and/or additionally, the rotation R′2 of the second tilting gear 156 may cause the same rotation R′2 of the second plate 118 about the axis A2. For example, the enlargement of the length L1o to the third length L12 may cause rotation R′3 of the third plate 124 about the axis A3 (e.g., an axis parallel to y-axis). Alternatively and/or additionally, the rotation R′3 of the third plate 124 may cause the same rotation R′3 of the third tilting gear 154 about the axis A3. Alternatively and/or additionally, the rotation R′3 of the third tilting gear 154 may cause rotation R′4 of the fourth tilting gear 158 about the axis A4 (e.g., an axis parallel to A3). Alternatively and/or additionally, the rotation R′4 of the fourth tilting gear 158 may cause the same rotation R′4 of the fourth plate 128 about the axis A4. In some examples, after the rotation R′1 of the first plate 122 about the first axis A1, the first plate 122 may comprise a fifth slope θ′1 wherein the fifth slope θ′1 is an angle between the first plate 122 and the line B1 (e.g., a line parallel to the z-axis). In some examples, after the rotation R′2 of the second plate 118 about the second axis A2, the second plate 118 may comprise a sixth slope θ′2 wherein the sixth slope θ′2 is an angle between the second plate 118 and the line B2 (e.g., a line parallel to the line B1). In some examples, after the rotation R′3 of the third plate 124 about the third axis A3, the third plate 124 may comprise a seventh slope θ′3 wherein the seventh slope θ′3 is an angle between the third plate 124 and the line B3 (e.g., a line parallel to the line B2). In some examples, after the rotation R′4 of the fourth plate 128 about the fourth axis A4, the fourth plate 128 may comprise an eighth slope θ′4 wherein the eighth slope θ′4 is an angle between the fourth plate 128 and the line B4 (e.g., a line parallel to the line B3). In some examples, the fifth slope θ′1 may be equal and/or opposite in polarity to the sixth slope θ′2. In some examples, the seventh slope θ′3 may be equal and/or opposite in polarity to the eighth slope θ′4. In some examples, the fifth slope θ′1 may be the same as the eighth slope θ′4. In some examples, the sixth slope e′2 may be the same as the seventh slope θ′3. In some examples, after the rotations R′1, R′2, R′3 and/or R′4, the distance D4₀ and/or the distance D3₀ may decrease to the distance D4₂ and/or the distance D3₂ respectively. Alternatively and/or additionally, the distance D6₀ and/or the distance D5₀ may increase to the distance D62 and/or the distance D5₂. In some examples, the distance D1₀ is equal to the distance D1₂ and/or the distance D2₀ is equal to the distance D22.

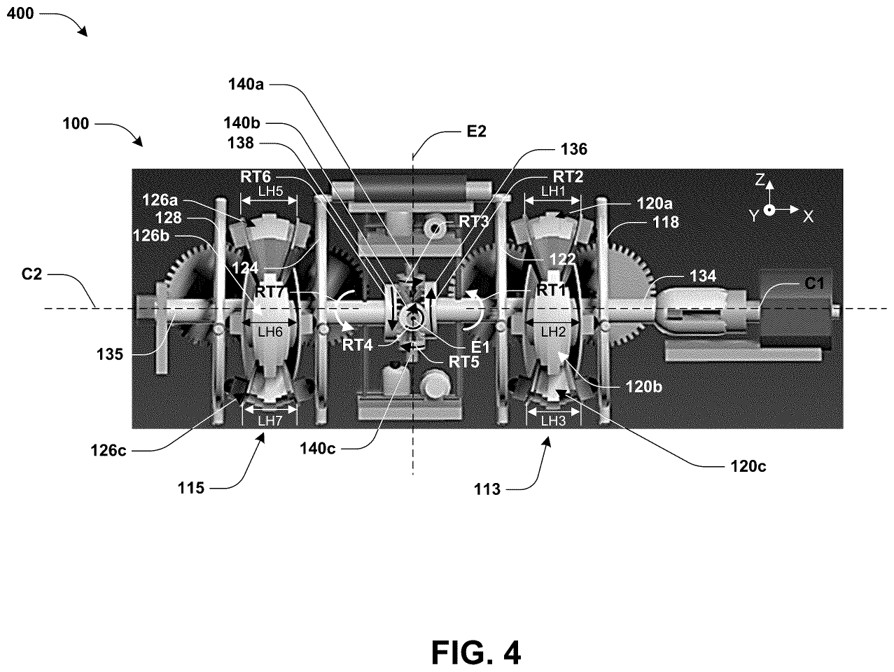

FIG. 4 illustrates a 2-dimensional front view 400 of the linear motion generation apparatus 100 showing operation of the gearbox 123 connected to aligned shafts in the linear motion generation apparatus 100 in a neutral state, according to some embodiments. In some examples, the neutral state is a state of operation of the linear motion generation apparatus 100 when the first plate 122 is parallel to the second plate 118 and/or the third plate 124 is parallel to the fourth plate 128. In some examples, the neutral state is a state of operation of the linear motion generation apparatus 100, wherein the linear motion generation apparatus 100 does not generate a linear force. In FIG. 4, a length LH1, a length LH2, a length LH3, a length LH5, a length LH6 and a length LH7 are shown. The length LH1 is the distance between the wheel 151a and the wheel 151b, the length LH2 is the distance between the wheel 153a and the wheel 153b, the length LH3 is the distance between the wheel 155a and the wheel 155b, the length LH4 (not shown) is the distance between the first wheel and the second wheel of the fourth hollow arm 120d, the length LH5 is the distance between the wheel 161a and the wheel 161b, the length LH6 is the distance between the wheel 163a and the wheel 163b, the length LH7 is the distance between the wheel 165a and the wheel 165b, and the length LH8 (not shown) is the distance between the first wheel and the second wheel of the eighth hollow arm 126d. In some examples, in neutral state during rotation of the first set of hollow arms 113 and/or the second set of hollow arms 115, the lengths LH1, LH2, LH3, LH4, LH5, LH6, LH7 and/or LH8 are constant. In some examples, the first shaft 134 and the second shaft 135 are aligned. In some examples, the first shaft 134 is parallel to the second shaft 135. In an example, the linear motion generation apparatus 100 is in the neutral state as such the linear motion generation apparatus 100 does not generate linear force. For example, the power generation unit 102 may cause rotation RT1 of the first shaft 134 about a line C1 (e.g., a line parallel to the x-axis). Alternatively and/or additionally, the rotation RT1 may cause rotation RT2 of the first gear 136 about the line C1. Alternatively and/or additionally, the rotation RT2 may cause: (i) rotation RT3 of the third gear 140a about a line E2, (ii) rotation RT4 of the fourth gear 140b about a line E1, (iii) rotation RT5 of the fifth gear 140c about the line E2, and/or (iv) rotation of the sixth gear 140d about the line E1. Alternatively and/or additionally, the rotations RT1, RT2, RT3, RT4, RT5 and/or the rotation of the sixth gear 140d may cause rotation RT6 of the second gear 138 about line C2 (e.g., a line parallel to the line C1). Alternatively and/or additionally, the rotation RT6 of the second gear 138 may cause rotation RT7 of the second shaft 135 about the line C2. In some examples, a direction of rotation of the first shaft 134 is opposite of a direction of rotation of the second shaft 135. In some examples, the rotation RT1 is clockwise and/or the rotation RT7 is counterclockwise. In some examples, the rotation RT1 is counterclockwise and/or the rotation RT7 is clockwise.

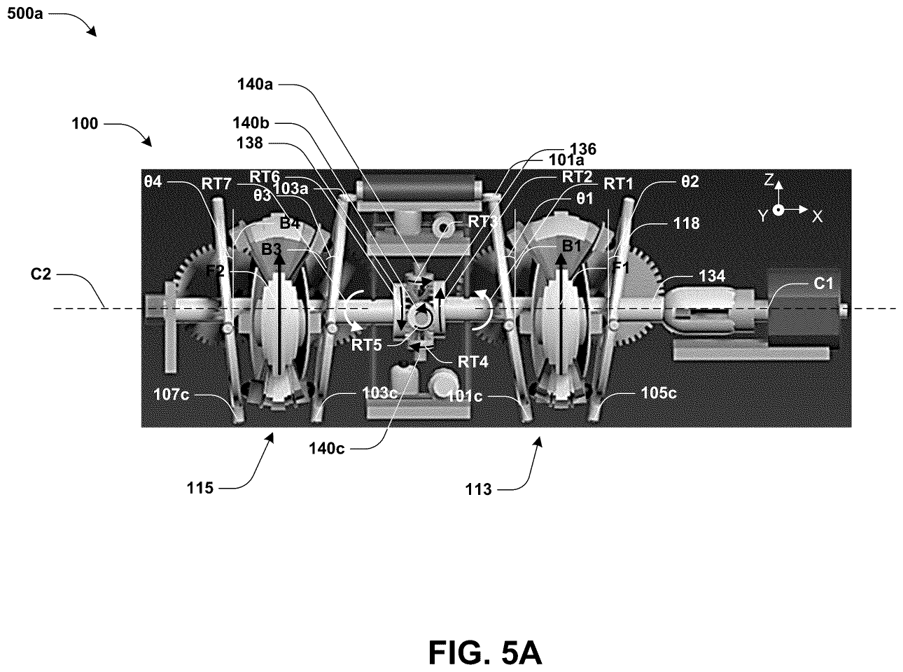

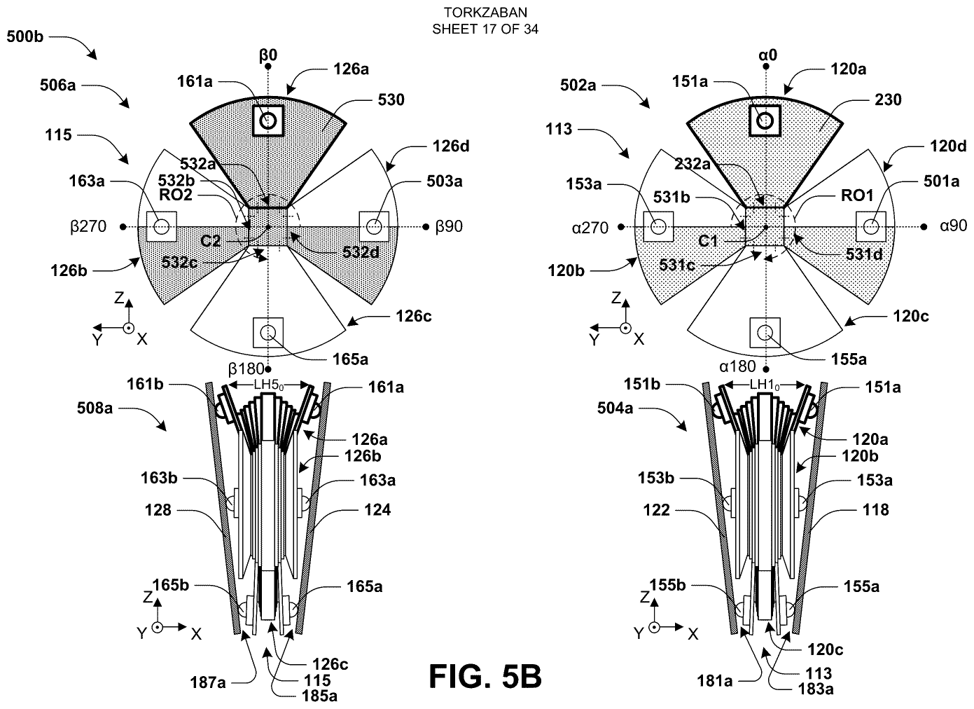

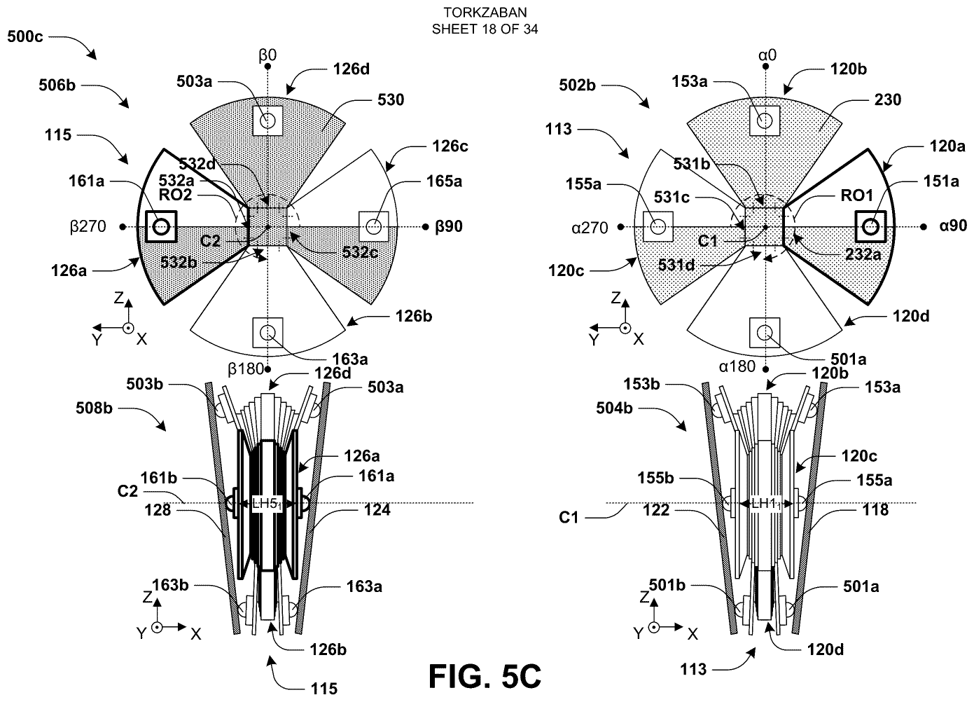

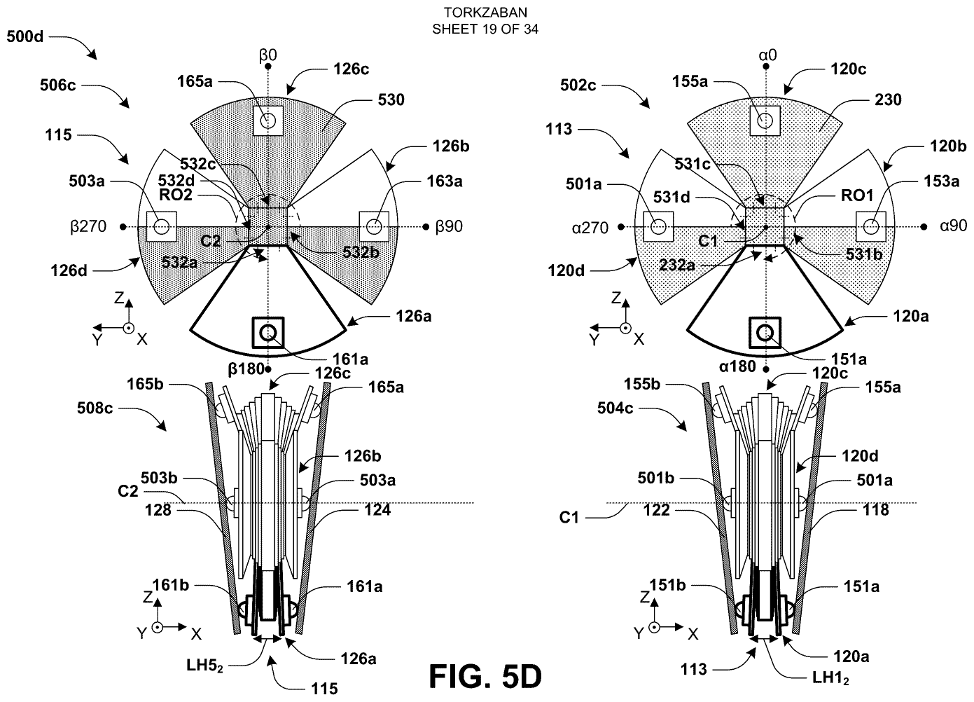

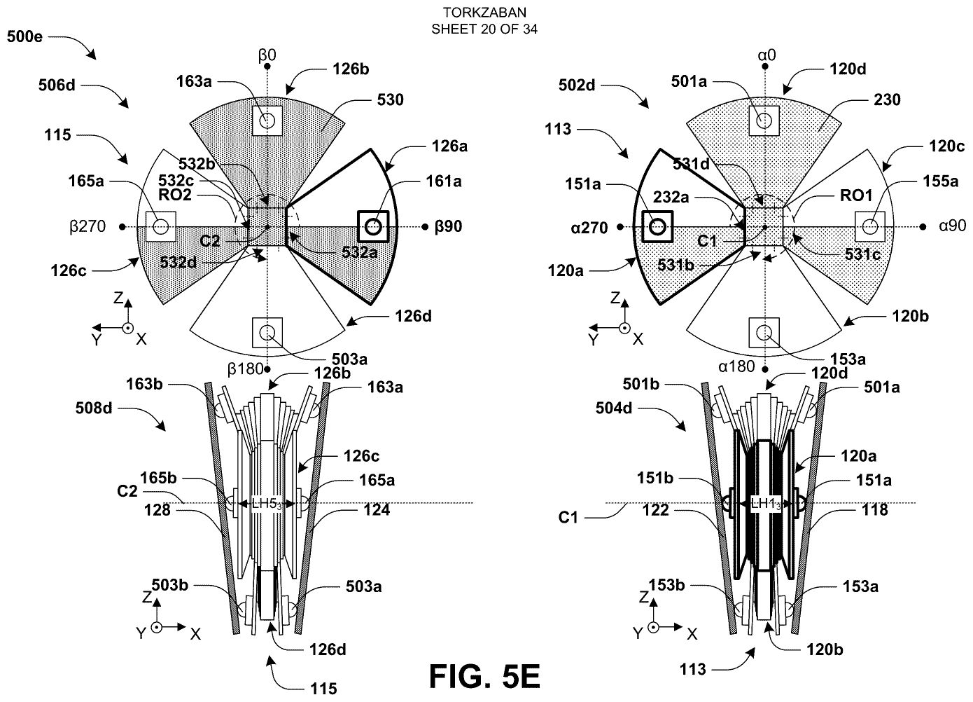

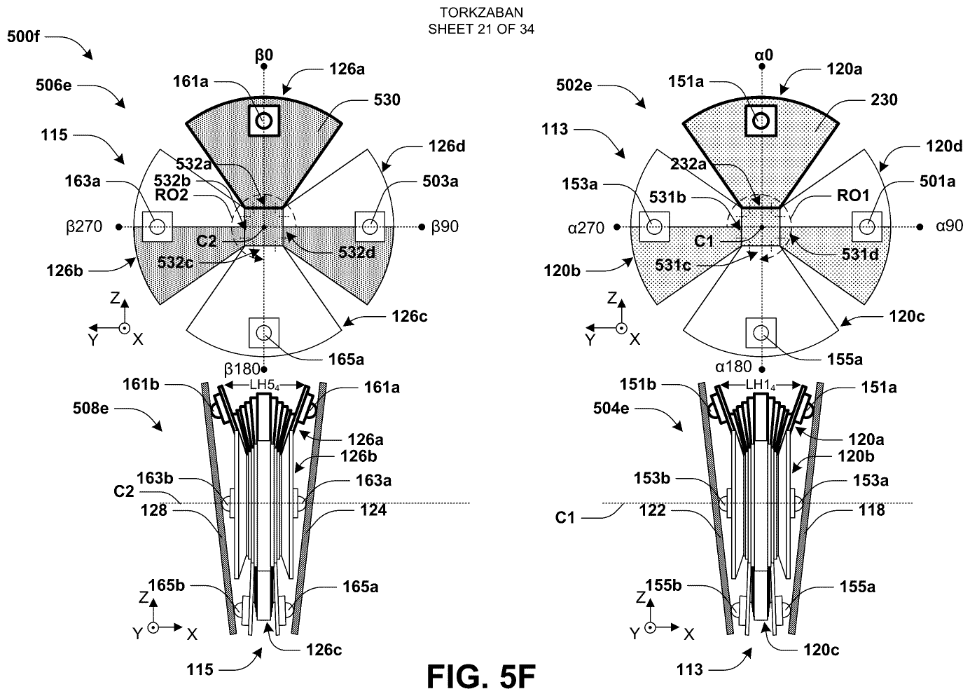

FIGS. 5A-5F illustrate operation of the linear motion generation apparatus 100 in upward force generation state in a full cycle of rotation (e.g., 360 degrees), according to some embodiments. FIG. 5A illustrates a 2-dimensional front view 500a of the linear motion generation apparatus 100 in upward force generation state (e.g., same as FIG. 3B), according to some embodiments. In some examples, rotation of the first set of hollow arms 113 about a line C1 (e.g., a line parallel to the x-axis) and/or rotation of the second set of hollow arms 115 about line C2 (e.g., a line parallel to the line C1) generates an upward force (e.g., a linear force in (+) z-direction).

In some examples, the first shaft 134 allows the first set of hollow arms 113 to rotate about a rotation axis (e.g., the line C1) with a first angular velocity. In some examples, the second shaft 135 allows the second set of hollow arms 115 to rotate about a rotation axis (e.g., the line C2) with a second angular velocity. In some examples, the second angular velocity may be different than the first angular velocity. Embodiments are contemplated in which the second angular velocity may be about equal to the first angular velocity.

FIG. 5B illustrates a 2-dimensional image 500b of the 2-dimensional front view 500a of the linear motion generation apparatus 100 in upward force generation state (e.g., same as FIG. 3B) at initial state of operation, according to some embodiments. The 2-dimensional image 500b comprises an image 502a of the first set of hollow arms 113 from side view (e.g., yz-plane view in xyz coordination system) at initial state of operation, an image 504a of the first set of hollow arms 113 from front view (e.g., xz-plane view in xyz coordination system) at initial state of operation, an image 506a of the second set of hollow arms 115 from side view (e.g., yz-plane view in xyz coordination system) at initial state of operation and an image 508a of the second set of hollow arms 115 from front view (e.g., xz-plane view in xyz coordination system) at initial state of operation. In some examples, the initial state of operation is when the linear motion generation apparatus 100 starts to operate. In some examples, the initial state of operation is when the length LH1₀ (e.g., distance between the wheel 151a and the wheel 151b corresponding to the first hollow arm 120a) is maximum during a full cycle (e.g., 360 degrees) of rotation. In some examples, the initial state of operation is when the length LH5₀ (e.g., distance between the wheel 161a and the wheel 161b corresponding to the fifth hollow arm 126a) is maximum during a full cycle (e.g., 360 degrees) of rotation. In an example, the rotation RT1 about the line C1 may cause rotation RO1 of the first set of hollow arms 113 about the line C1 and/or the rotation RT5 about the line C2 may cause rotation RO2 of the second set of hollow arms 115 about the line C2. In some examples, a direction of the rotation RO1 is apposite to a direction of the rotation RO2. With respect to FIGS. 5A-5F, the direction of the rotation RO1 is clockwise and/or the direction of the rotation RO2 is counterclockwise.

In FIG. 5B, the image 502a and/or the image 504a illustrate that the first hollow arm 120a may rotate (e.g., 90 degrees) from point α0 to point α90 in a clockwise rotation about the line C1. Alternatively and/or additionally, the second hollow arm 120b may rotate (e.g., 90 degrees) from point α270 to point α0 in a clockwise rotation about the line C1. Alternatively and/or additionally, the third hollow arm 120c may rotate (e.g., 90 degrees) from point α180 to point α270 in a clockwise rotation about the line C1. Alternatively and/or additionally, the fourth hollow arm 120d may rotate (e.g., 90 degrees) from point α90 to point α180 in a clockwise rotation about the line C1. The image 506a and/or the image 508a illustrate that the fifth hollow arm 126a may rotate (e.g., 90 degrees) from point β0 to point β270 in counterclockwise rotation about the line C2. Alternatively and/or additionally, the sixth hollow arm 126b may rotate (e.g., 90 degrees) from point β270 to point β180 in a counterclockwise rotation about the line C2. Alternatively and/or additionally, the seventh hollow arm 126c may rotate (e.g., 90 degrees) from point β180 to point β90 in a counterclockwise rotation about the line C2. Alternatively and/or additionally, the eighth hollow arm 126d may rotate (e.g., 90 degrees) from point β90 to point β0 in a counterclockwise rotation about the line C2.

In FIG. 5B, rotation of the first hollow arm 120a from point α0 to point α90 in a clockwise rotation about the line C1 may cause rotation and/or movement of the wheel 151a from point α0 to point α90 on the second surface 183a of the second plate 118 and/or about the line C1. Alternatively and/or additionally, rotation of the first hollow arm 120a from point α0 to point α90 in a clockwise rotation about the line C1 may cause rotation and/or movement of the wheel 151b from point α0 to point α90 on the first surface 181a of the first plate 122 and/or about the line C1. Rotation of the second hollow arm 120b from point α270 to point α0 in a clockwise rotation about the line C1 may cause rotation and/or movement of the wheel 153a from point α270 to point α0 on the second surface 183a of the second plate 118 and/or about the line C1. Alternatively and/or additionally, rotation of the second hollow arm 120b from point α270 to point α0 in a clockwise rotation about the line C1 may cause rotation and/or movement of the wheel 153b from point α270 to point α0 on the first surface 181a of the first plate 122 and/or about the line C1. Rotation of the third hollow arm 120c from point α180 to point α270 in a clockwise rotation about the line C1 may cause rotation and/or movement of the wheel 155a from point α180 to point α270 on the second surface 183a of the second plate 118 and/or about the line C1. Alternatively and/or additionally, rotation of the third hollow arm 120c from point α180 to point α270 in a clockwise rotation about the line C1 may cause rotation and/or movement of the wheel 155b from point α180 to point α270 on the first surface 181a of the first plate 122 and/or about the line C1. Rotation of the fourth hollow arm 120d from point α90 to point α180 in a clockwise rotation about the line C1 may cause rotation and/or movement of a wheel 501a from point α90 to point α180 on the second surface 183a of the second plate 118 and/or about the line C1. Alternatively and/or additionally, rotation of the fourth hollow arm 120d from point α90 to point α180 in a clockwise rotation about the line C1 may cause rotation and/or movement of the second wheel (not shown) of the fourth hollow arm 120d from point α90 to point α180 on the first surface 181a of the first plate 122 and/or about the line C1. In FIG. 5B, rotation of the fifth hollow arm 126a from point β0 to point β270 in a counterclockwise rotation about the line C2 may cause rotation and/or movement of the wheel 161a from point β0 to point β270 on the first surface 185a of the third plate 124 and/or about the line C2. Alternatively and/or additionally, rotation of the fifth hollow arm 126a from point β0 to point β270 in a counterclockwise rotation about the line C2 may cause rotation and/or movement of the wheel 161b from point β0 to point β270 on the second surface 187a of the fourth plate 128 and/or about the line C2. Rotation of the sixth hollow arm 126b from point β270 to point β180 in a counterclockwise rotation about the line C2 may cause rotation and/or movement of the wheel 163a from point β270 to point β180 on the first surface 185a of the third plate 124 and/or about the line C2. Alternatively and/or additionally, rotation of the sixth hollow arm 126b from point β270 to point β180 in a counterclockwise rotation about the line C2 may cause rotation and/or movement of the wheel 163b from point β270 to point β180 on the second surface 187a of the fourth plate 128 and/or about the line C2. Rotation of the seventh hollow arm 126c from point β180 to point β90 in a counterclockwise rotation about the line C2 may cause rotation and/or movement of the wheel 165a from point β180 to point β90 on the first surface 185a of the third plate 124 and/or about the line C2. Alternatively and/or additionally, rotation of the seventh hollow arm 126c from point β180 to point β90 in a counterclockwise rotation about the line C2 may cause rotation and/or movement of the wheel 165b from point β180 to point β90 on the second surface 187a of the fourth plate 128 and/or about the line C2. Rotation of the eighth hollow arm 126d from point β90 to point β0 in a counterclockwise rotation about the line C2 may cause rotation and/or movement of a wheel 503a from point β90 to point β0 on the first surface 185a of the third plate 124 and/or about the line C2. Alternatively and/or additionally, rotation of the eighth hollow arm 126d from point β90 to point β0 in a counterclockwise rotation about the line C2 may cause rotation and/or movement of the second wheel (not shown) of the eighth hollow arm 126d from point β90 to point β0 on the second surface 187a of the fourth plate 128 and/or about the line C2.

FIG. 5C illustrates a 2-dimensional image 500c of the 2-dimensional front view 500a of the linear motion generation apparatus 100 in upward force generation state (e.g., same as FIG. 3B) at second state of operation, according to some embodiments. The 2-dimensional image 500c comprises an image 502b of the first set of hollow arms 113 from side view (e.g., yz-plane view in xyz coordination system) at second state of operation, an image 504b of the first set of hollow arms 113 from front view (e.g., xz-plane view in xyz coordination system) at the second state of operation, an image 506b of the second set of hollow arms 115 from side view (e.g., yz-plane view in xyz coordination system) at second state of operation and an image 508b of the second set of hollow arms 115 from front view (e.g., xz-plane view in xyz coordination system) at second state of operation. In some examples, the second state of operation is when the linear motion generation apparatus 100 continues to rotate (e.g., 90 degrees) the first hollow arm 120a from point α90 to point α180 in a clockwise rotation. In some examples, the second state of operation starts when the length LH1₀ may be reduced to length LH1₁ (e.g., distance between the wheel 151a and the wheel 151b corresponding to the first hollow arm 120a when the first hollow arm 120a passes the point α90) during a full cycle (e.g., 360 degrees) of rotation. In some examples, the second state of operation starts when the length LH5₀ may be reduced to length LH5₁ (e.g., distance between the wheel 161a and the wheel 161b corresponding to the fifth hollow arm 126a when the fifth hollow arm 126a passes the point β270) during a full cycle (e.g., 360 degrees) of rotation.

In FIG. 5C, the image 502b and/or the image 504b illustrate that the first hollow arm 120a may rotate (e.g., 90 degrees) from point α90 to point α180 in a clockwise rotation about the line C1. Alternatively and/or additionally, the second hollow arm 120b may rotate (e.g., 90 degrees) from point α0 to point α90 in a clockwise rotation about the line C1. Alternatively and/or additionally, the third hollow arm 120c may rotate (e.g., 90 degrees) from point α270 to point α0 in a clockwise rotation about the line C1. Alternatively and/or additionally, the fourth hollow arm 120d may rotate (e.g., 90 degrees) from point α180 to point α270 in a clockwise rotation about the line C1. The image 506b and/or the image 508b illustrate that the fifth hollow arm 126a may rotate (e.g., 90 degrees) from point β270 to point β180 in counterclockwise rotation about the line C2. Alternatively and/or additionally, the sixth hollow arm 126b may rotate (e.g., 90 degrees) from point β180 to point β90 in a counterclockwise rotation about the line C2. Alternatively and/or additionally, the seventh hollow arm 126c may rotate (e.g., 90 degrees) from point β90 to point β0 in a counterclockwise rotation about the line C2. Alternatively and/or additionally, the eighth hollow arm 126d may rotate (e.g., 90 degrees) from point β0 to point β270 in a counterclockwise rotation about the line C2.

In FIG. 5C, rotation of the first hollow arm 120a from point α90 to point α180 in a clockwise rotation about the line C1 may cause rotation and/or movement of the wheel 151a from point α90 to point α180 on the second surface 183a of the second plate 118 and/or about the line C1. Alternatively and/or additionally, rotation of the first hollow arm 120a from point α90 to point α180 in a clockwise rotation about the line C1 may cause rotation and/or movement of the wheel 151b from point α90 to point α180 on the first surface 181a of the first plate 122 and/or about the line C1. Rotation of the second hollow arm 120b from point α0 to point α270 in a clockwise rotation about the line C1 may cause rotation and/or movement of the wheel 153a from point α0 to point α90 on the second surface 183a of the second plate 118 and/or about the line C1. Alternatively and/or additionally, rotation of the second hollow arm 120b from point α0 to point α90 in a clockwise rotation about the line C1 may cause rotation and/or movement of the wheel 153b from point α0 to point α90 on the first surface 181a of the first plate 122 and/or about the line C1. Rotation of the third hollow arm 120c from point α270 to point α0 in a clockwise rotation about the line C1 may cause rotation and/or movement of the wheel 155a from point α270 to point α0 on the second surface 183a of the second plate 118 and/or about the line C1. Alternatively and/or additionally, rotation of the third hollow arm 120c from point α270 to point α0 in a clockwise rotation about the line C1 may cause rotation and/or movement of the wheel 155b from point α270 to point α0 on the first surface 181a of the first plate 122 and/or about the line C1. Rotation of the fourth hollow arm 120d from point α180 to point α270 in a clockwise rotation about the line C1 may cause rotation and/or movement of the wheel 501a from point α180 to point α270 on the second surface 183a of the second plate 118 and/or about the line C1. Alternatively and/or additionally, rotation of the fourth hollow arm 120d from point α180 to point α270 in a clockwise rotation about the line C1 may cause rotation and/or movement of the second wheel (shown with reference number 501b) of the fourth hollow arm 120d from point α180 to point α270 on the first surface 181a of the first plate 122 and/or about the line C1. In FIG. 5C, rotation of the fifth hollow arm 126a from point β270 to point β180 in a counterclockwise rotation about the line C2 may cause rotation and/or movement of the wheel 161a from point β270 to point β180 on the first surface 185a of the third plate 124 and/or about the line C2. Alternatively and/or additionally, rotation of the fifth hollow arm 126a from point β270 to point β180 in a counterclockwise rotation about the line C2 may cause rotation and/or movement of the wheel 161b from point β270 to point β180 on the second surface 187a of the fourth plate 128 and/or about the line C2. Rotation of the sixth hollow arm 126b from point β180 to point β90 in a counterclockwise rotation about the line C2 may cause rotation and/or movement of the wheel 163a from point β180 to point β90 on the first surface 185a of the third plate 124 and/or about the line C2. Alternatively and/or additionally, rotation of the sixth hollow arm 126b from point β180 to point β90 in a counterclockwise rotation about the line C2 may cause rotation and/or movement of the wheel 163b from point β180 to point β90 on the second surface 187a of the fourth plate 128 and/or about the line C2. Rotation of the seventh hollow arm 126c from point β90 to point β0 in a counterclockwise rotation about the line C2 may cause rotation and/or movement of the wheel 165a from point β90 to point β0 on the first surface 185a of the third plate 124 and/or about the line C2. Alternatively and/or additionally, rotation of the seventh hollow arm 126c from point β90 to point β0 in a counterclockwise rotation about the line C2 may cause rotation and/or movement of the wheel 165b from point β90 to point β0 on the second surface 187a of the fourth plate 128 and/or about the line C2. Rotation of the eighth hollow arm 126d from point β0 to point β270 in a counterclockwise rotation about the line C2 may cause rotation and/or movement of the wheel 503a from point β0 to point β270 on the first surface 185a of the third plate 124 and/or about the line C2. Alternatively and/or additionally, rotation of the eighth hollow arm 126d from point β0 to point β270 in a counterclockwise rotation about the line C2 may cause rotation and/or movement of the second wheel (shown with reference number 503b) of the eighth hollow arm 126d from point β0 to point β270 on the second surface 187a of the fourth plate 128 and/or about the line C2.

FIG. 5D illustrates a 2-dimensional image 500d of the 2-dimensional front view 500a of the linear motion generation apparatus 100 in upward force generation state (e.g., same as FIG. 3B) at third state of operation, according to some embodiments. The 2-dimensional image 500d comprises an image 502c of the first set of hollow arms 113 from side view (e.g., yz-plane view in xyz coordination system) at third state of operation, an image 504c of the first set of hollow arms 113 from front view (e.g., xz-plane view in xyz coordination system) at the third state of operation, an image 506c of the second set of hollow arms 115 from side view (e.g., yz-plane view in xyz coordination system) at third state of operation and an image 508c of the second set of hollow arms 115 from front view (e.g., xz-plane view in xyz coordination system) at third state of operation. In some examples, the third state of operation is when the linear motion generation apparatus 100 continues to rotate (e.g., 90 degrees) the first hollow arm 120a from point α180 to point α270 in a clockwise rotation. In some examples, the third state of operation starts when the length LH1₁ may be reduced to length LH12 (e.g., distance between the wheel 151a and the wheel 151b corresponding to the first hollow arm 120a when the first hollow arm 120a passes the point α180) during a full cycle (e.g., 360 degrees) of rotation. In some examples, the length LH1₂ is the minimum length of LH1 during a full cycle (e.g., 360 degrees) of rotation. In some examples, the third state of operation starts when the length LH5₁ may be reduced to length LH5₂ (e.g., distance between the wheel 161a and the wheel 161b corresponding to the fifth hollow arm 126a when the fifth hollow arm 126a passes the point β180) during a full cycle (e.g., 360 degrees) of rotation. In some examples, the length LH5₂ is the minimum length of LH5 during a full cycle (e.g., 360 degrees) of rotation.

In FIG. 5D, the image 502c and/or the image 504c illustrate that the first hollow arm 120a may rotate (e.g., 90 degrees) from point α180 to point α270 in a clockwise rotation about the line C1. Alternatively and/or additionally, the second hollow arm 120b may rotate (e.g., 90 degrees) from point α90 to point α180 in a clockwise rotation about the line C1. Alternatively and/or additionally, the third hollow arm 120c may rotate (e.g., 90 degrees) from point α0 to point α90 in a clockwise rotation about the line C1. Alternatively and/or additionally, the fourth hollow arm 120d may rotate (e.g., 90 degrees) from point α270 to point α0 in a clockwise rotation about the line C1. The image 506c and/or the image 508c illustrate that the fifth hollow arm 126a may rotate (e.g., 90 degrees) from point β180 to point β90 in counterclockwise rotation about the line C2. Alternatively and/or additionally, the sixth hollow arm 126b may rotate (e.g., 90 degrees) from point β90 to point β0 in a counterclockwise rotation about the line C2. Alternatively and/or additionally, the seventh hollow arm 126c may rotate (e.g., 90 degrees) from point β0 to point β270 in a counterclockwise rotation about the line C2. Alternatively and/or additionally, the eighth hollow arm 126d may rotate (e.g., 90 degrees) from point β270 to point β180 in a counterclockwise rotation about the line C2.

In FIG. 5D, rotation of the first hollow arm 120a from point α180 to point α270 in a clockwise rotation about the line C1 may cause rotation and/or movement of the wheel 151a from point α180 to point α270 on the second surface 183a of the second plate 118 and/or about the line C1. Alternatively and/or additionally, rotation of the first hollow arm 120a from point α180 to point α270 in a clockwise rotation about the line C1 may cause rotation and/or movement of the wheel 151b from point α180 to point α270 on the first surface 181a of the first plate 122 and/or about the line C1. Rotation of the second hollow arm 120b from point α90 to point α180 in a clockwise rotation about the line C1 may cause rotation and/or movement of the wheel 153a from point α90 to point α180 on the second surface 183a of the second plate 118 and/or about the line C1. Alternatively and/or additionally, rotation of the second hollow arm 120b from point α90 to point α180 in a clockwise rotation about the line C1 may cause rotation and/or movement of the wheel 153b from point α90 to point α180 on the first surface 181a of the first plate 122 and/or about the line C1. Rotation of the third hollow arm 120c from point α0 to point α90 in a clockwise rotation about the line C1 may cause rotation and/or movement of the wheel 155a from point α0 to point α90 on the second surface 183a of the second plate 118 and/or about the line C1. Alternatively and/or additionally, rotation of the third hollow arm 120c from point α0 to point α90 in a clockwise rotation about the line C1 may cause rotation and/or movement of the wheel 155b from point α0 to point α90 on the first surface 181a of the first plate 122 and/or about the line C1. Rotation of the fourth hollow arm 120d from point α270 to point α0 in a clockwise rotation about the line C1 may cause rotation and/or movement of the wheel 501a from point α270 to point α0 on the second surface 183a of the second plate 118 and/or about the line C1. Alternatively and/or additionally, rotation of the fourth hollow arm 120d from point α270 to point α0 in a clockwise rotation about the line C1 may cause rotation and/or movement of the second wheel 501b of the fourth hollow arm 120d from point α270 to point α180 on the first surface 181a of the first plate 122 and/or about the line C1. In FIG. 5D, rotation of the fifth hollow arm 126a from point β180 to point β90 in a counterclockwise rotation about the line C2 may cause rotation and/or movement of the wheel 161a from point β180 to point β90 on the first surface 185a of the third plate 124 and/or about the line C2. Alternatively and/or additionally, rotation of the fifth hollow arm 126a from point β180 to point β90 in a counterclockwise rotation about the line C2 may cause rotation and/or movement of the wheel 161b from point β180 to point β90 on the second surface 187a of the fourth plate 128 and/or about the line C2. Rotation of the sixth hollow arm 126b from point β90 to point β0 in a counterclockwise rotation about the line C2 may cause rotation and/or movement of the wheel 163a from point β90 to point β0 on the first surface 185a of the third plate 124 and/or about the line C2. Alternatively and/or additionally, rotation of the sixth hollow arm 126b from point β90 to point β0 in a counterclockwise rotation about the line C2 may cause rotation and/or movement of the wheel 163b from point β90 to point β0 on the second surface 187a of the fourth plate 128 and/or about the line C2. Rotation of the seventh hollow arm 126c from point β0 to point β270 in a counterclockwise rotation about the line C2 may cause rotation and/or movement of the wheel 165a from point β0 to point β270 on the first surface 185a of the third plate 124 and/or about the line C2. Alternatively and/or additionally, rotation of the seventh hollow arm 126c from point β0 to point β270 in a counterclockwise rotation about the line C2 may cause rotation and/or movement of the wheel 165b from point β0 to point β270 on the second surface 187a of the fourth plate 128 and/or about the line C2. Rotation of the eighth hollow arm 126d from point β270 to point β180 in a counterclockwise rotation about the line C2 may cause rotation and/or movement of the wheel 503a from point β270 to point β180 on the first surface 185a of the third plate 124 and/or about the line C2. Alternatively and/or additionally, rotation of the eighth hollow arm 126d from point β270 to point β180 in a counterclockwise rotation about the line C2 may cause rotation and/or movement of the second wheel 503b of the eighth hollow arm 126d from point β270 to point β180 on the second surface 187a of the fourth plate 128 and/or about the line C2.

FIG. 5E illustrates a 2-dimensional image 500e of the 2-dimensional front view 500a of the linear motion generation apparatus 100 in upward force generation state (e.g., same as FIG. 3B) at fourth state of operation, according to some embodiments. The 2-dimensional image 500e comprises an image 502d of the first set of hollow arms 113 from side view (e.g., yz-plane view in xyz coordination system) at fourth state of operation, an image 504d of the first set of hollow arms 113 from front view (e.g., xz-plane view in xyz coordination system) at the fourth state of operation, an image 506d of the second set of hollow arms 115 from side view (e.g., yz-plane view in xyz coordination system) at the fourth state of operation and an image 508d of the second set of hollow arms 115 from front view (e.g., xz-plane view in xyz coordination system) at the fourth state of operation. In some examples, the fourth state of operation is when the linear motion generation apparatus 100 continues to rotate the first hollow arm 120a (e.g., 90 degrees) from point α270 to point α0 (e.g., point β60) in a clockwise rotation. In some examples, the fourth state of operation starts when the length LH1₂ may be enlarged to length LH1₃ (e.g., distance between the wheel 151a and the wheel 151b corresponding to the first hollow arm 120a when the first hollow arm 120a passes the point α270) during a full cycle (e.g., 360 degrees) of rotation. In some examples, the fourth state of operation starts when the length LH5₂ may be enlarged to length LH5₃ (e.g., distance between the wheel 161a and the wheel 161b corresponding to the fifth hollow arm 126a when the fifth hollow arm 126a passes the point β90) during a full cycle (e.g., 360 degrees) of rotation.

In FIG. 5E, the image 502d and/or the image 504d illustrate that the first hollow arm 120a may rotate (e.g., 90 degrees) from point α270 to point α0 in a clockwise rotation about the line C1. Alternatively and/or additionally, the second hollow arm 120b may rotate (e.g., 90 degrees) from point α180 to point α270 in a clockwise rotation about the line C1. Alternatively and/or additionally, the third hollow arm 120c may rotate (e.g., 90 degrees) from point α90 to point α180 in a clockwise rotation about the line C1. Alternatively and/or additionally, the fourth hollow arm 120d may rotate (e.g., 90 degrees) from point α0 to point α90 in a clockwise rotation about the line C1. The image 506d and/or the image 508d illustrate that the fifth hollow arm 126a may rotate (e.g., 90 degrees) from point β90 to point β0 in counterclockwise rotation about the line C2. Alternatively and/or additionally, the sixth hollow arm 126b may rotate (e.g., 90 degrees) from point β to point β270 in a counterclockwise rotation about the line C2. Alternatively and/or additionally, the seventh hollow arm 126c may rotate (e.g., 90 degrees) from point β270 to point β180 in a counterclockwise rotation about the line C2. Alternatively and/or additionally, the eighth hollow arm 126d may rotate (e.g., 90 degrees) from point β180 to point β90 in a counterclockwise rotation about the line C2.

In FIG. 5E, rotation of the first hollow arm 120a from point α270 to point α0 in a clockwise rotation about the line C1 may cause rotation and/or movement of the wheel 151a from point α270 to point α0 on the second surface 183a of the second plate 118 and/or about the line C1. Alternatively and/or additionally, rotation of the first hollow arm 120a from point α270 to point α0 in a clockwise rotation about the line C1 may cause rotation and/or movement of the wheel 151b from point α270 to point α0 on the first surface 181a of the first plate 122 and/or about the line C1. Rotation of the second hollow arm 120b from point α180 to point α270 in a clockwise rotation about the line C1 may cause rotation and/or movement of the wheel 153a from point α180 to point α270 on the second surface 183a of the second plate 118 and/or about the line C1. Alternatively and/or additionally, rotation of the second hollow arm 120b from point α180 to point α270 in a clockwise rotation about the line C1 may cause rotation and/or movement of the wheel 153b from point α180 to point α270 on the first surface 181a of the first plate 122 and/or about the line C1. Rotation of the third hollow arm 120c from point α90 to point α180 in a clockwise rotation about the line C1 may cause rotation and/or movement of the wheel 155a from point α90 to point α180 on the second surface 183a of the second plate 118 and/or about the line C1. Alternatively and/or additionally, rotation of the third hollow arm 120c from point α90 to point α180 in a clockwise rotation about the line C1 may cause rotation and/or movement of the wheel 155b from point α90 to point α180 on the first surface 181a of the first plate 122 and/or about the line C1. Rotation of the fourth hollow arm 120d from point α0 to point α90 in a clockwise rotation about the line C1 may cause rotation and/or movement of the wheel 501a from point α0 to point α90 on the second surface 183a of the second plate 118 and/or about the line C1. Alternatively and/or additionally, rotation of the fourth hollow arm 120d from point α0 to point α90 in a clockwise rotation about the line C1 may cause rotation and/or movement of the second wheel 501b of the fourth hollow arm 120d from point α0 to point α90 on the first surface 181a of the first plate 122 and/or about the line C1. In FIG. 5E, rotation of the fifth hollow arm 126a from point β90 to point β0 in a counterclockwise rotation about the line C2 may cause rotation and/or movement of the wheel 161a from point 390 to point β0 on the first surface 185a of the third plate 124 and/or about the line C2. Alternatively and/or additionally, rotation of the fifth hollow arm 126a from point β90 to point β0 in a counterclockwise rotation about the line C2 may cause rotation and/or movement of the wheel 161b from point β90 to point β0 on the second surface 187a of the fourth plate 128 and/or about the line C2. Rotation of the sixth hollow arm 126b from point β0 to point β270 in a counterclockwise rotation about the line C2 may cause rotation and/or movement of the wheel 163a from point β0 to point β270 on the first surface 185a of the third plate 124 and/or about the line C2. Alternatively and/or additionally, rotation of the sixth hollow arm 126b from point β0 to point β270 in a counterclockwise rotation about the line C2 may cause rotation and/or movement of the wheel 163b from point β0 to point β270 on the second surface 187a of the fourth plate 128 and/or about the line C2. Rotation of the seventh hollow arm 126c from point β270 to point β180 in a counterclockwise rotation about the line C2 may cause rotation and/or movement of the wheel 165a from point β270 to point β180 on the first surface 185a of the third plate 124 and/or about the line C2. Alternatively and/or additionally, rotation of the seventh hollow arm 126c from point β270 to point β180 in a counterclockwise rotation about the line C2 may cause rotation and/or movement of the wheel 165b from point β270 to point β180 on the second surface 187a of the fourth plate 128 and/or about the line C2. Rotation of the eighth hollow arm 126d from point β180 to point β90 in a counterclockwise rotation about the line C2 may cause rotation and/or movement of the wheel 503a from point β180 to point β90 on the first surface 185a of the third plate 124 and/or about the line C2. Alternatively and/or additionally, rotation of the eighth hollow arm 126d from point β180 to point β90 in a counterclockwise rotation about the line C2 may cause rotation and/or movement of the second wheel 503b of the eighth hollow arm 126d from point β180 to point β90 on the second surface 187a of the fourth plate 128 and/or about the line C2.

FIG. 5F illustrates a 2-dimensional image 500f of the 2-dimensional front view 500a of the linear motion generation apparatus 100 in upward force generation state (e.g., same as FIG. 3B) at final state of operation, according to some embodiments. The 2-dimensional image 500f comprises an image 502e of the first set of hollow arms 113 from side view (e.g., yz-plane view in xyz coordination system) at final state of operation, an image 504e of the first set of hollow arms 113 from front view (e.g., xz-plane view in xyz coordination system) at final state of operation, an image 506e of the second set of hollow arms 115 from side view (e.g., yz-plane view in xyz coordination system) at final state of operation and an image 508e of the second set of hollow arms 115 from front view (e.g., xz-plane view in xyz coordination system) at final state of operation for one full cycle of rotation. In some examples, the final state of operation is when the linear motion generation apparatus 100 completes a full cycle of rotation (e.g., 360 degrees). In some examples, the final state of operation is when the length LH1₄ (e.g., distance between the wheel 151a and the wheel 151b corresponding to the first hollow arm 120a) is maximum during a full cycle (e.g., 360 degrees) of rotation. In some examples, the final state of operation is when the length LH54 (e.g., distance between the wheel 161a and the wheel 161b corresponding to the fifth hollow arm 126a) is maximum during a full cycle (e.g., 360 degrees) of rotation.

In FIG. 5F, the image 502e and/or the image 504e illustrate that the first hollow arm 120a may rotate (e.g., 90 degrees) from point α0 to point α90 in a clockwise rotation about the line C1. Alternatively and/or additionally, the second hollow arm 120b may rotate (e.g., 90 degrees) from point α270 to point α0 in a clockwise rotation about the line C1. Alternatively and/or additionally, the third hollow arm 120c may rotate (e.g., 90 degrees) from point α180 to point α270 in a clockwise rotation about the line C1. Alternatively and/or additionally, the fourth hollow arm 120d may rotate (e.g., 90 degrees) from point α90 to point α180 in a clockwise rotation about the line C1. The image 506e and/or the image 508e illustrate that the fifth hollow arm 126a may rotate (e.g., 90 degrees) from point β0 to point β270 in counterclockwise rotation about the line C2. Alternatively and/or additionally, the sixth hollow arm 126b may rotate (e.g., 90 degrees) from point β270 to point β180 in a counterclockwise rotation about the line C2. Alternatively and/or additionally, the seventh hollow arm 126c may rotate (e.g., 90 degrees) from point β180 to point β90 in a counterclockwise rotation about the line C2. Alternatively and/or additionally, the eighth hollow arm 126d may rotate (e.g., 90 degrees) from point β90 to point β0 in a counterclockwise rotation about the line C2.

In FIG. 5F, rotation of the first hollow arm 120a from point α0 to point α90 in a clockwise rotation about the line C1 may cause rotation and/or movement of the wheel 151a from point α0 to point α90 on the second surface 183a of the second plate 118 and/or about the line C1. Alternatively and/or additionally, rotation of the first hollow arm 120a from point α0 to point α90 in a clockwise rotation about the line C1 may cause rotation and/or movement of the wheel 151b from point α0 to point α90 on the first surface 181a of the first plate 122 and/or about the line C1. Rotation of the second hollow arm 120b from point α270 to point α0 in a clockwise rotation about the line C1 may cause rotation and/or movement of the wheel 153a from point α270 to point α0 on the second surface 183a of the second plate 118 and/or about the line C1. Alternatively and/or additionally, rotation of the second hollow arm 120b from point α270 to point α0 in a clockwise rotation about the line C1 may cause rotation and/or movement of the wheel 153b from point α270 to point α0 on the first surface 181a of the first plate 122 and/or about the line C1. Rotation of the third hollow arm 120c from point α180 to point α270 in a clockwise rotation about the line C1 may cause rotation and/or movement of the wheel 155a from point α180 to point α270 on the second surface 183a of the second plate 118 and/or about the line C1. Alternatively and/or additionally, rotation of the third hollow arm 120c from point α180 to point α270 in a clockwise rotation about the line C1 may cause rotation and/or movement of the wheel 155b from point α180 to point α270 on the first surface 181a of the first plate 122 and/or about the line C1. Rotation of the fourth hollow arm 120d from point α90 to point α180 in a clockwise rotation about the line C1 may cause rotation and/or movement of the wheel 501a from point α90 to point α180 on the second surface 183a of the second plate 118 and/or about the line C1. Alternatively and/or additionally, rotation of the fourth hollow arm 120d from point α90 to point α180 in a clockwise rotation about the line C1 may cause rotation and/or movement of the second wheel 501b of the fourth hollow arm 120d from point α90 to point α180 on the first surface 181a of the first plate 122 and/or about the line C1. In FIG. 5F, rotation of the fifth hollow arm 126a from point β0 to point β270 in a counterclockwise rotation about the line C2 may cause rotation and/or movement of the wheel 161a from point β0 to point β270 on the first surface 185a of the third plate 124 and/or about the line C2. Alternatively and/or additionally, rotation of the fifth hollow arm 126a from point β0 to point β270 in a counterclockwise rotation about the line C2 may cause rotation and/or movement of the wheel 161b from point β0 to point β270 on the second surface 187a of the fourth plate 128 and/or about the line C2. Rotation of the sixth hollow arm 126b from point β270 to point β180 in a counterclockwise rotation about the line C2 may cause rotation and/or movement of the wheel 163a from point β270 to point β180 on the first surface 185a of the third plate 124 and/or about the line C2. Alternatively and/or additionally, rotation of the sixth hollow arm 126b from point β270 to point β180 in a counterclockwise rotation about the line C2 may cause rotation and/or movement of the wheel 163b from point β270 to point β180 on the second surface 187a of the fourth plate 128 and/or about the line C2. Rotation of the seventh hollow arm 126c from point β180 to point β90 in a counterclockwise rotation about the line C2 may cause rotation and/or movement of the wheel 165a from point β180 to point β90 on the first surface 185a of the third plate 124 and/or about the line C2. Alternatively and/or additionally, rotation of the seventh hollow arm 126c from point β180 to point β90 in a counterclockwise rotation about the line C2 may cause rotation and/or movement of the wheel 165b from point β180 to point β90 on the second surface 187a of the fourth plate 128 and/or about the line C2. Rotation of the eighth hollow arm 126d from point β90 to point β0 in a counterclockwise rotation about the line C2 may cause rotation and/or movement of the wheel 503a from point β90 to point β0 on the first surface 185a of the third plate 124 and/or about the line C2. Alternatively and/or additionally, rotation of the eighth hollow arm 126d from point β90 to point β0 in a counterclockwise rotation about the line C2 may cause rotation and/or movement of the second wheel 503b of the eighth hollow arm 126d from point β90 to point β0 on the second surface 187a of the fourth plate 128 and/or about the line C2.

In some examples, after rotation of the first set of hollow arms 113 from the initial state of operation to the second state of operation (and/or while the first set of hollow arms 113 are in the second state of operation), (i) a first portion of the first fluid 230 may exit from the first hollow arm 120a via the first opening 232a, (ii) a second portion of the first fluid 230 may exit from the fourth hollow arm 120d via the fourth opening (shown with reference number 531d), (iii) a third portion of the first fluid 230 may enter the third hollow arm 120c via the third opening (shown with reference number 531c) (e.g., the third portion of the first fluid 230 may comprise at least some of the first portion of the first fluid 230 and/or at least some of the second portion of the first fluid 230), and/or (iv) a fourth portion of the first fluid 230 may enter the second hollow arm 120b via the second opening (shown with reference number 531b) (e.g., the fourth portion of the first fluid 230 may comprise at least some of the first portion of the first fluid 230 and/or at least some of the second portion of the first fluid 230). In some examples, after rotation of the second set of hollow arms 115 from the initial state of operation to the second state of operation (and/or while the second set of hollow arms 115 are in the second state of operation), (i) a first portion of the second fluid 530 may exit from the fifth hollow arm 126a via the fifth opening (shown with reference number 532a), (ii) a second portion of the second fluid 530 may exit from the sixth hollow arm 126b via the sixth opening (shown with reference number 532b), (iii) a third portion of the second fluid 530 may enter the seventh hollow arm 126c via the seventh opening (shown with reference number 532c) (e.g., the third portion of the second fluid 530 may comprise at least some of the first portion of the second fluid 530 and/or at least some of the second portion of the second fluid 530), and/or (iv) a fourth portion of the second fluid 530 may enter the eighth hollow arm 126d via the eighth opening (shown with reference number 532d) (e.g., the fourth portion of the second fluid 530 may comprise at least some of the first portion of the second fluid 530 and/or at least some of the second portion of the second fluid 530.

In some examples, according to rotation of the first set of hollow arms 113 from the initial state of operation to the second state of operation, the length LH1₀ reduces to the length LH1₁. The reduction of the length LH1₀ to the length LH1₁ may be based upon a first pressure applied from the first plate 122 and/or the second plate 118. The first pressure may be generated from reduction of the distance D3₁ (shown in FIG. 3B) to the distance D1₁ (shown in FIG. 3B). In some examples, according to rotation of the second set of hollow arms 115 from the initial state of operation to the second state of operation, the length LH5₀ reduces to the length LH5₁. The reduction of the length LH5₀ to the length LH5₁ may be based upon a second pressure applied from the third plate 124 and/or the fourth plate 128. The second pressure may be generated from reduction of the distance D4₁ (shown in FIG. 3B) to the distance D2₁ (shown in FIG. 3B).

In some examples, after rotation of the first set of hollow arms 113 from the second state of operation to the third state of operation (and/or while the first set of hollow arms 113 are in the third state of operation), (i) a first portion of the first fluid 230 may exit from the second hollow arm 120b via the second opening 531b, (ii) a second portion of the first fluid 230 may exit from the first hollow arm 120a via the first opening 232a, (iii) a third portion of the first fluid 230 may enter the fourth hollow arm 120d via the fourth opening 531d (e.g., the third portion of the first fluid 230 may comprise at least some of the first portion of the first fluid 230 and/or at least some of the second portion of the first fluid 230), and/or (iv) a fourth portion of the first fluid 230 may enter the third hollow arm 120c via the third opening 531c (e.g., the fourth portion of the first fluid 230 may comprise at least some of the first portion of the first fluid 230 and/or at least some of the second portion of the first fluid 230). In some examples, after rotation of the second set of hollow arms 115 from the second state of operation to the third state of operation (and/or while the second set of hollow arms 115 are in the third state of operation), (i) a first portion of the second fluid 530 may exit from the eighth hollow arm 126d via the eighth opening 532d, (ii) a second portion of the second fluid 530 may exit from the fifth hollow arm 126a via the fifth opening 532a, (iii) a third portion of the second fluid 530 may enter the sixth hollow arm 126b via the sixth opening 532b (e.g., the third portion of the second fluid 530 may comprise at least some of the first portion of the second fluid 530 and/or at least some of the second portion of the second fluid 530), and/or (iv) a fourth portion of the second fluid 530 may enter the seventh hollow arm 126c via the seventh opening 532c (e.g., the fourth portion of the second fluid 530 may comprise at least some of the first portion of the second fluid 530 and/or at least some of the second portion of the second fluid 530.

In some examples, according to rotation of the first set of hollow arms 113 from the second state of operation to the third state of operation, the length LH1₁ reduces to the length LH1₂. The reduction of the length LH1₁ to the length LH1₂ may be based upon a third pressure applied from the first plate 122 and/or the second plate 118. The third pressure may be generated from reduction of the distance D1₁ (shown in FIG. 3B) to the distance D5₁ (shown in FIG. 3B). In some examples, according to rotation of the second set of hollow arms 115 from the second state of operation to the third state of operation, the length LH5₁ reduces to the length LH5₂. The reduction of the length LH5₁ to the length LH5₂ may be based upon a fourth pressure applied from the third plate 124 and/or the fourth plate 128. The fourth pressure may be generated from reduction of the distance D2₁ (shown in FIG. 3B) to the distance D6₁ (shown in FIG. 3B).

In some examples, after rotation of the first set of hollow arms 113 from the third state of operation to the fourth state of operation (and/or while the first set of hollow arms 113 are in the fourth state of operation), (i) a first portion of the first fluid 230 may exit from the third hollow arm 120c via the third opening 531c, (ii) a second portion of the first fluid 230 may exit from the second hollow arm 120b via the second opening 531b, (iii) a third portion of the first fluid 230 may enter the first hollow arm 120a via the first opening 232a (e.g., the third portion of the first fluid 230 may comprise at least some of the first portion of the first fluid 230 and/or at least some of the second portion of the first fluid 230), and/or (iv) a fourth portion of the first fluid 230 may enter the fourth hollow arm 120d via the fourth opening 531d (e.g., the fourth portion of the first fluid 230 may comprise at least some of the first portion of the first fluid 230 and/or at least some of the second portion of the first fluid 230). In some examples, after rotation of the second set of hollow arms 115 from the third state of operation to the fourth state of operation (and/or while the second set of hollow arms 115 are in the third state of operation), (i) a first portion of the second fluid 530 may exit from the seventh hollow arm 126c via the seventh opening 532c, (ii) a second portion of the second fluid 530 may exit from the eighth hollow arm 126d via the eighth opening 532d, (iii) a third portion of the second fluid 530 may enter the sixth hollow arm 126b via the sixth opening 532b (e.g., the third portion of the second fluid 530 may comprise at least some of the first portion of the second fluid 530 and/or at least some of the second portion of the second fluid 530), and/or (iv) a fourth portion of the second fluid 530 may enter the fifth hollow arm 126a via the fifth opening 532a (e.g., the fourth portion of the second fluid 530 may comprise at least some of the first portion of the second fluid 530 and/or at least some of the second portion of the second fluid 530.

In some examples, according to rotation of the first set of hollow arms 113 from the third state of operation to the fourth state of operation, the length LH1₂ increases to the length LH1₃. The increasing of the length LH1₂ to the length LH1₃ may be based upon a fifth pressure applied from at least a first portion of the first fluid 230 entering the first hollow arm 120a. In some examples, according to rotation of the second set of hollow arms 115 from the third state of operation to the fourth state of operation, the length LH5₂ increases to the length LH5₃. The increasing of the length LH5₂ to the length LH5₃ may be based upon a sixth pressure applied from at least a first portion of the second fluid 530 entering the sixth hollow arm 126a.

In some examples, after rotation of the first set of hollow arms 113 from the fourth state of operation to the final state of operation (and/or while the first set of hollow arms 113 are in the final state of operation), (i) a first portion of the first fluid 230 may exit from the fourth hollow arm 120d via the fourth opening 531d, (ii) a second portion of the first fluid 230 may exit from the third hollow arm 120c via the third opening 531c, (iii) a third portion of the first fluid 230 may enter the first hollow arm 120a via the first opening 232a (e.g., the third portion of the first fluid 230 may comprise at least some of the first portion of the first fluid 230 and/or at least some of the second portion of the first fluid 230), and/or (iv) a fourth portion of the first fluid 230 may enter the second hollow arm 120b via the second opening 531b (e.g., the fourth portion of the first fluid 230 may comprise at least some of the first portion of the first fluid 230 and/or at least some of the second portion of the first fluid 230). In some examples, after rotation of the second set of hollow arms 115 from the fourth state of operation to the final state of operation (and/or while the second set of hollow arms 115 are in the final state of operation), (i) a first portion of the second fluid 530 may exit from the sixth hollow arm 126b via the sixth opening 532b, (ii) a second portion of the second fluid 530 may exit from the seventh hollow arm 126c via the seventh opening 532c, (iii) a third portion of the second fluid 530 may enter the eighth hollow arm 126d via the eighth opening 532d (e.g., the third portion of the second fluid 530 may comprise at least some of the first portion of the second fluid 530 and/or at least some of the second portion of the second fluid 530), and/or (iv) a fourth portion of the second fluid 530 may enter the fifth hollow arm 126a via the fifth opening 532a (e.g., the fourth portion of the second fluid 530 may comprise at least some of the first portion of the second fluid 530 and/or at least some of the second portion of the second fluid 530.

In some examples, according to rotation of the first set of hollow arms 113 from the fourth state of operation to the final state of operation, the length LH1₃ increases to the length LH1₄. The increasing of the length LH1₃ to the length LH1₄ may be based upon a seventh pressure applied from at least a second portion of the first fluid 230 entering the first hollow arm 120a. In some examples, according to rotation of the second set of hollow arms 115 from the fourth state of operation to the final state of operation, the length LH5₃ increases to the length LH54. The increasing of the length LH5₃ to the length LH5₄ may be based upon an eighth pressure applied from at least a second portion of the second fluid 530 entering the fifth hollow arm 126a.

With respect to FIGS. 5A-5F, rotation of the first set of hollow arms 113 inside the first plate 122 and the second plate 118 and/or movement of the first fluid 230 inside the first set of hollow arms 113 may generate a first linear force F1 via moving the first fluid 230 inside the first set of hollow arms 113. In an example, rotation of the second set of hollow arms 115 inside the third plate 124 and the fourth plate 128 and/or movement of the second fluid 530 inside the second set of hollow arms 115 may generate a second linear force F2 via moving the second fluid 530 inside the second set of hollow arms 115. In some examples, the first fluid 230 is the same as the second fluid 530. In some examples, the first linear force F1 comprises a first x-component force (F1ₓ), a first y-component force (F1_{y}) and/or a first z-component force (F1_{z}). In some examples, the second linear force F2 comprises a second x-component force (F2ₓ), a second y-component force (F2_{y}) and/or a second z-component force (F2_{z}). With respect to FIGS. 5A-5F, the first x-component force (F1ₓ) and/or the second x-component force (F2ₓ) may be zero. In some examples, an amount of the first y-component force (F1_{y}) may be equal to an amount of the second y-component force (F2_{y}) and/or a direction of the first y-component force3 (F1_{y}) may be opposite to a direction of the second y-component force (F2_{y}), therefore the sum of the first y-component force (F1_{y}) and the second y-component force (F2_{y}) may be zero. In some examples, an amount and/or a direction of the first z-component force (F1_{z}) may be equal to an amount and/or a direction of the second z-component force (F2_{z}). In some examples, a resultant force may apply to the linear motion generation apparatus 100 wherein the resultant force may be a linear force in z-direction as though the linear force in (+) z-direction is the sum of the first z-component (F1_{z}) and the second z-component (F2_{z}).

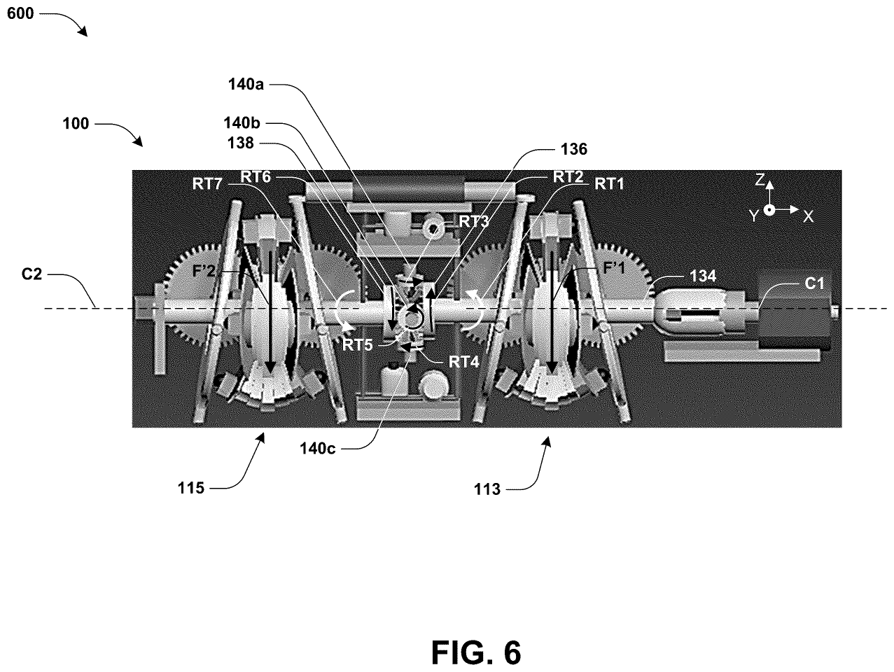

FIG. 6 illustrates a 2-dimensional front view 600 of the linear motion generation apparatus 100 in downward force generation state (e.g., same as FIG. 3C), according to some embodiments. In some examples, rotation of the first set of hollow arms 113 about a line C1 (e.g., a line parallel to the x-axis) and/or rotation of the second set of hollow arms 115 about line C2 (e.g., a line parallel to the line C1) generates a downward force (e.g., a linear force in (−) z-direction).

With respect to FIG. 6 (similar to FIGS. 5A-5F), rotation of the first set of hollow arms 113 inside the first plate 122 and the second plate 118 and/or movement of the first fluid 230 inside the first set of hollow arms 113 may generate a first linear force F′1 via moving the first fluid 230 inside the first set of hollow arms 113. In an example, rotation of the second set of hollow arms 115 inside the third plate 124 and the fourth plate 128 and/or movement of the second fluid 530 inside the second set of hollow arms 115 may generate a second linear force F′2 via moving the second fluid 530 (shown in FIGS. 5B-5F) inside the second set of hollow arms 115. In some examples, the first fluid 230 is the same as the second fluid 530. In some examples, the first linear force F′1 comprises a first x-component force (F′1ₓ), a first y-component force (F′1_{y}) and/or a first z-component force (F′1_{z}). In some examples, the second linear force F′2 comprises a second x-component force (F′2ₓ), a second y-component force (F′2_{y}) and/or a second z-component force (F′2_{z}). With respect to FIG. 6, the first x-component force (F′1ₓ) and/or the second x-component force (F′2ₓ) may be zero. In some examples, an amount of the first y-component force (F′1_{y}) may be equal to an amount of the second y-component force (F′2_{y}) and/or a direction of the first y-component force3 (F′1_{y}) may be opposite to a direction of the second y-component force (F′2_{y}), therefore the sum of the first y-component force (F′1_{y}) and the second y-component force (F′2_{y}) may be zero. In some examples, an amount and/or a direction of the first z-component force (F′1_{z}) may be equal to an amount and/or a direction of the second z-component force (F′2_{z}). In some examples, a resultant force may apply to the linear motion generation apparatus 100 wherein the resultant force may be a linear force in z-direction as though the linear force in (−) z-direction is the sum of the first z-component (F′1_{z}) and the second z-component (F′2_{z}).

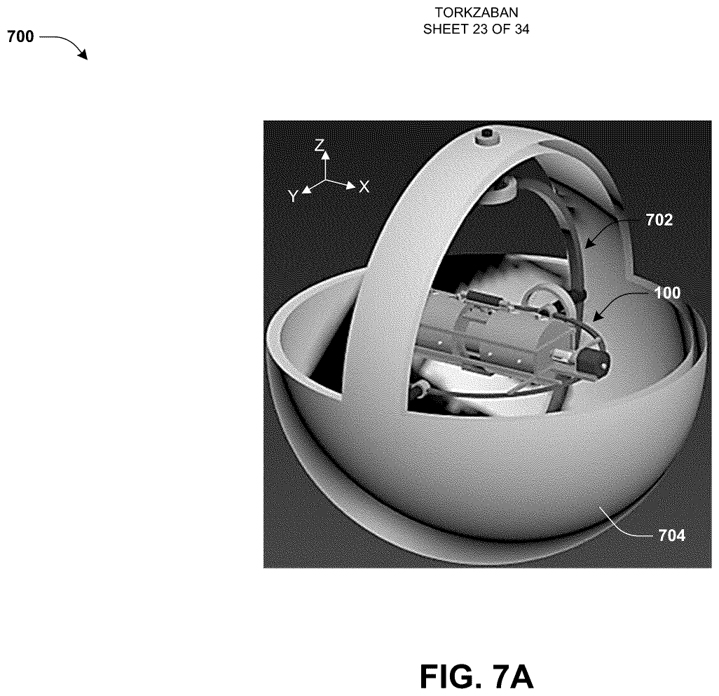

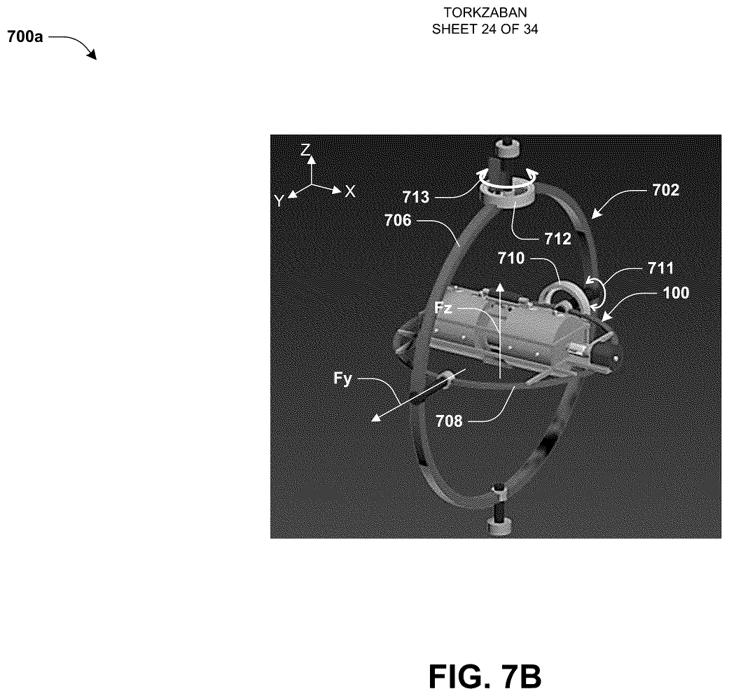

FIG. 7A, illustrates a force steering system 700 (e.g., a power steering device) to obtain a desired force direction for the linear motion generation apparatus 100, according to some embodiments. In some examples, the force steering system 700 may comprise the linear motion generation apparatus 100, a force steering device 702 (e.g., a power steering device) and/or a casing 704. FIG. 7B, illustrates an image 700a of the linear motion generation apparatus 100 mounted on the force steering device 702. In some examples, the force steering device 702 may comprise a first rotating ring 708 and/or a second rotating ring 706. In some examples, the first rotating ring 708 may be attached to a first rotating system 710 and/or the second rotating ring 706 may be attached to a second rotating system 712. In some examples, the first rotating system 710 may apply a first rotation 711 on the linear motion generation apparatus 100 and/or the second rotating system 712 may apply a second rotation 713 on the linear motion generation apparatus 100. In some examples, by applying a first rotation 711 and/or a second rotation 713, the force steering system 700 may be able to obtain a desired direction to the force generated by the linear motion generation apparatus 100. For example, Fz is the force generated by the linear motion generation apparatus 100. The force steering system 700 is able to change a direction of the force Fz to a force Fy. In order to change the direction of the force Fz to the force Fy, the force steering system 700 may apply the first rotation 711 (e.g., by 90 degrees about y-axis) on the linear motion generation apparatus 100 and apply the second rotation 713 (e.g., by 90 degrees about z-axis) on the linear motion generation apparatus 100.

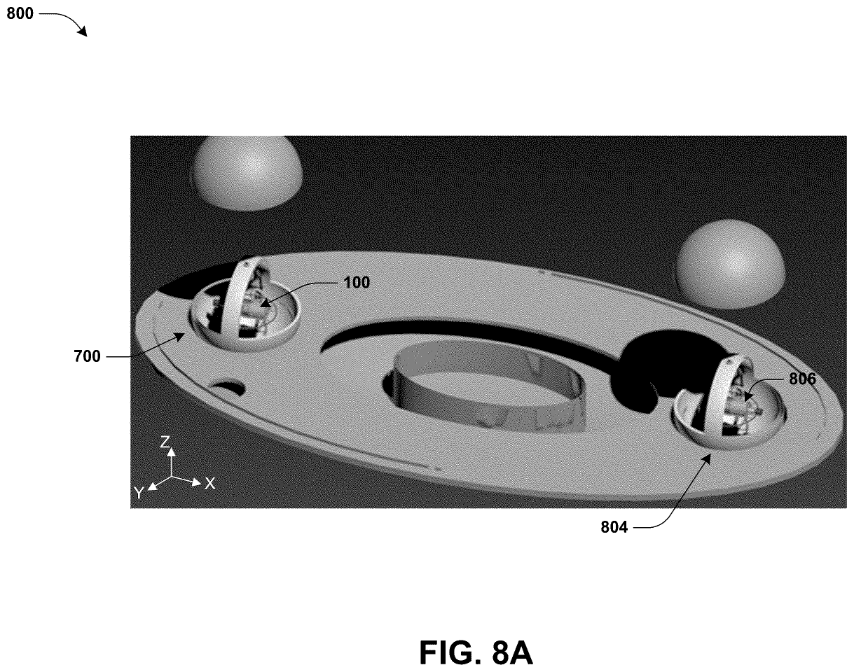

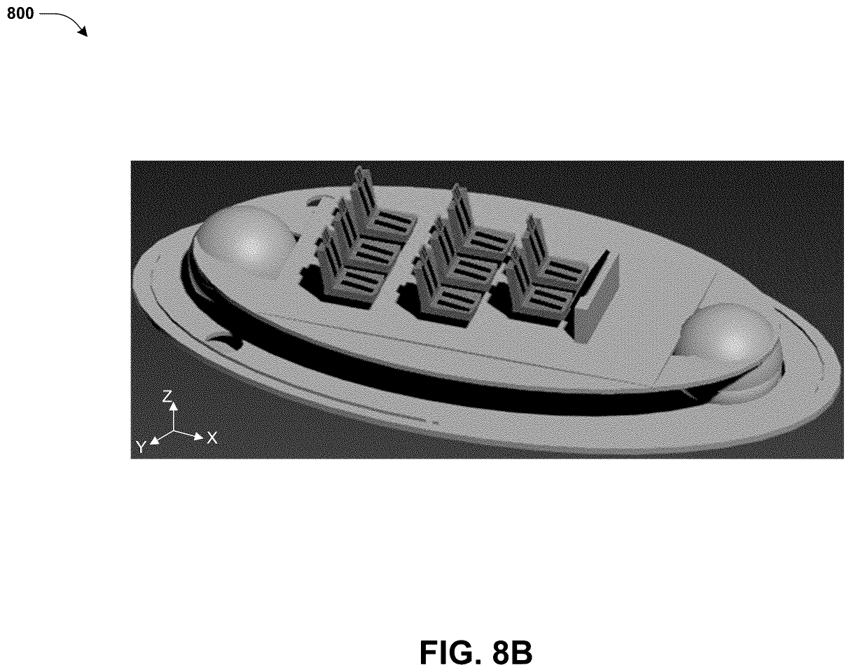

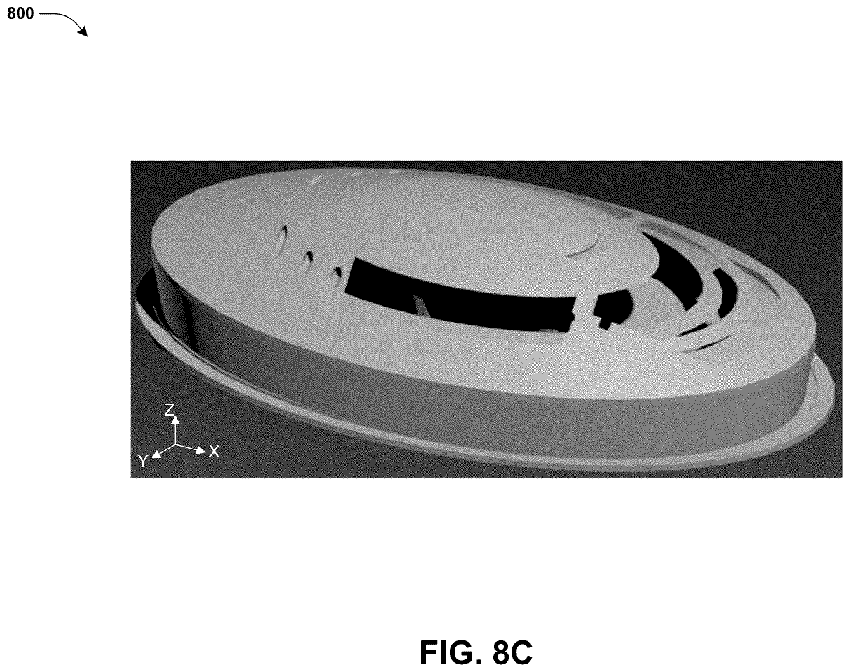

FIGS. 8A-8C illustrate a vehicle 800, according to some embodiments. In some examples, the vehicle 800 comprises a force steering system 700 and/or a second force steering system 804. In some examples, the vehicle 800 is a UFO-shaped vehicle. In some examples, the vehicle 800 is an aerial vehicle, such as a Vertical Take-Off and Landing (VTOL) vehicle and/or other type of aerial vehicle. In some examples, the vehicle 800 is a spacecraft for traveling through space. In some examples, the vehicle 800 is a nautical vehicle for traveling through a body of water. In FIGS. 8A-8C, the vehicle 800 comprises the linear motion generation apparatus 100 and/or a second linear motion generation apparatus 806 (which may be operated using one or more of the techniques provided herein with respect to the linear motion generation apparatus 100, for example). For example, linear motion and/or other forces generated using the linear motion generation apparatus 100 and/or the second linear motion generation apparatus 806 may be used to (i) move the vehicle 800 (via a thrust force provided by the linear motion generation apparatus 100 and/or the second linear motion generation apparatus 806), (ii) lift the vehicle 800, (iii) keep the vehicle 800 hovering and/or levitating in a target position, and/or (iv) perform one or more other operations. In some examples, the linear motion generation apparatus 100 is mounted on the force steering system 700 and/or the second linear motion generation apparatus 806 is mounted on the second force steering system 804. In some examples, the vehicle 800 can move in water and/or can fly in air and/or space. In some examples, the vehicle 800 can move in every direction (e.g., x-direction, y-direction and/or z-direction) via utilizing the force steering system 700 and/or the second force steering system 804.

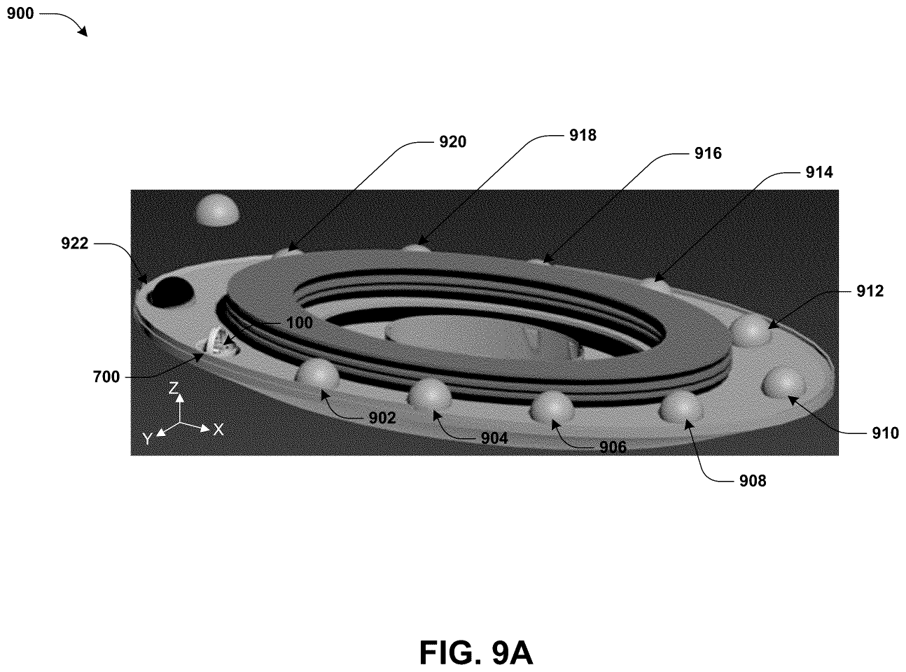

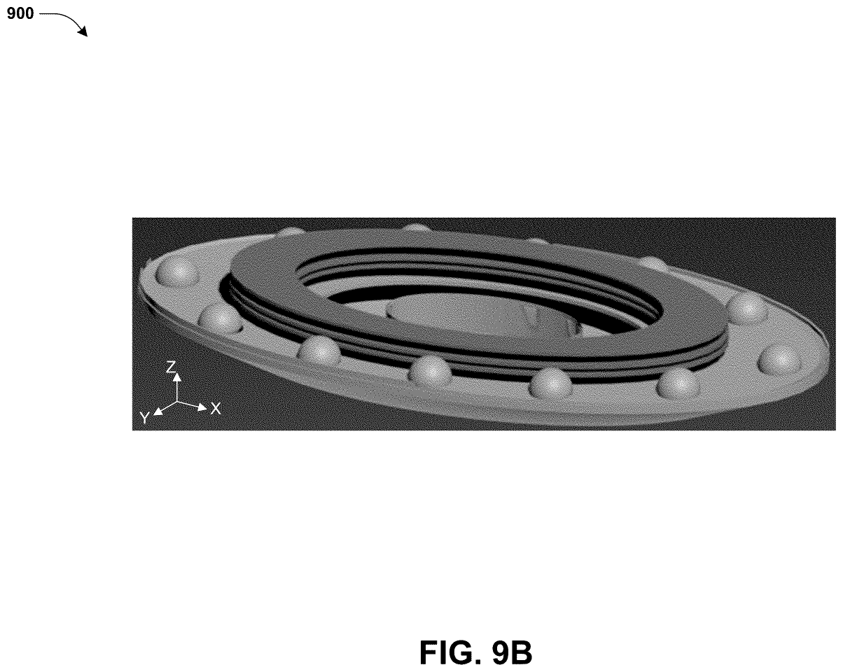

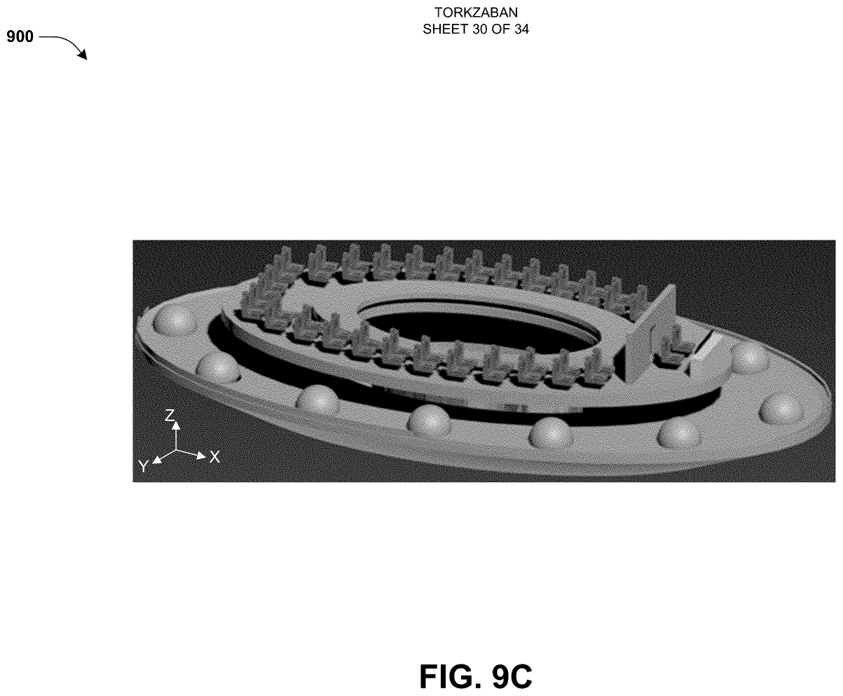

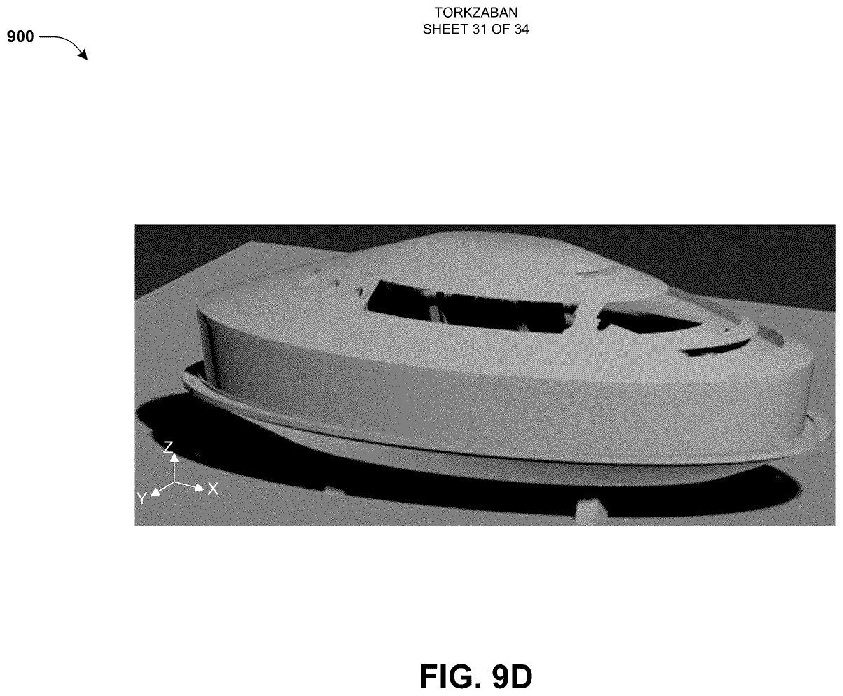

FIGS. 9A-9D illustrate a vehicle 900 (e.g., a UFO-shaped vehicle, an aerial vehicle, a spacecraft, a nautical vehicle, etc.), according to some embodiments. In FIGS. 9A-9D, the vehicle 900 comprises the linear motion generation apparatus 100, a second linear motion generation apparatus, a third linear motion generation apparatus, a fourth linear motion generation apparatus, a linear fifth motion generation apparatus, a sixth linear motion generation apparatus, a seventh linear motion generation apparatus, an eighth linear motion generation apparatus, a linear ninth motion generation apparatus, a tenth linear motion generation apparatus, an eleventh linear motion generation apparatus, and/or a twelfth linear motion generation apparatus. In some examples, the linear motion generation apparatus 100 is mounted on the force steering system 700, the second motion generation apparatus is mounted on a second force steering system 902, the third motion generation apparatus is mounted on a third force steering system 904, the fourth motion generation apparatus is mounted on a fourth force steering system 906, the fifth motion generation apparatus is mounted on a fifth force steering system 908, the sixth motion generation apparatus is mounted on a sixth force steering system 910, the seventh motion generation apparatus is mounted on a seventh force steering system 912, the eighth motion generation apparatus is mounted on an eighth force steering system 914, the ninth motion generation apparatus is mounted on a ninth force steering system 916, the tenth motion generation apparatus is mounted on a tenth force steering system 918, the eleventh motion generation apparatus is mounted on an eleventh force steering system 920 and/or the twelfth motion generation apparatus is mounted on a twelfth force steering system 922. In some examples, the vehicle 900 can move in water and/or can fly in air and/or space. In some examples, the vehicle 900 can move in every direction (e.g., x-direction, y-direction and/or z-direction) via utilizing at least one of the force steering system 700, the second force steering system 902, the third force steering system 904, the fourth force steering system 906, the fifth force steering system 908, the sixth force steering system 910, the seventh force steering system 912, the eighth force steering system 914, the ninth force steering system 916, the tenth force steering system 918, the eleventh force steering system 920 and/or the twelfth force steering system 922.

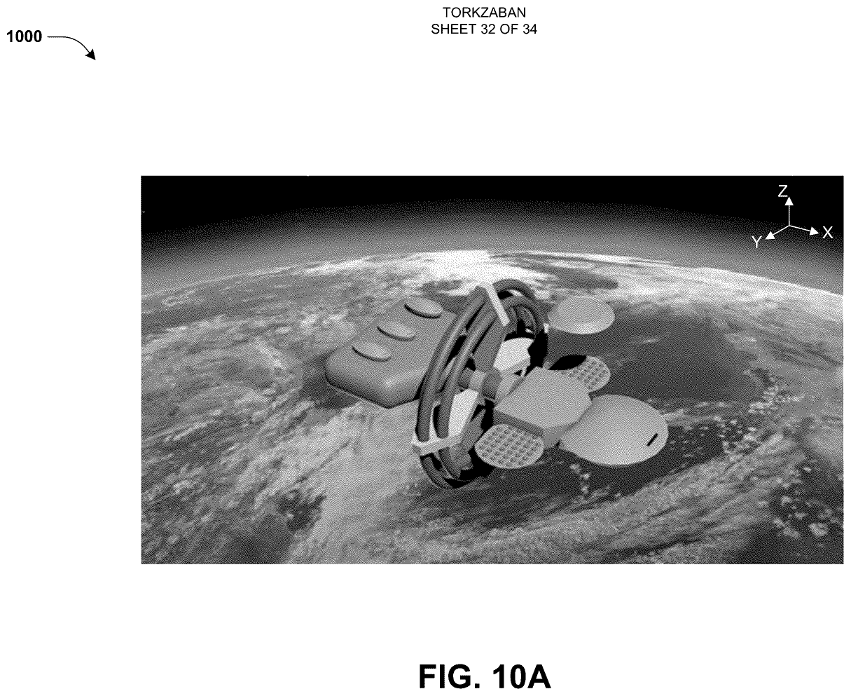

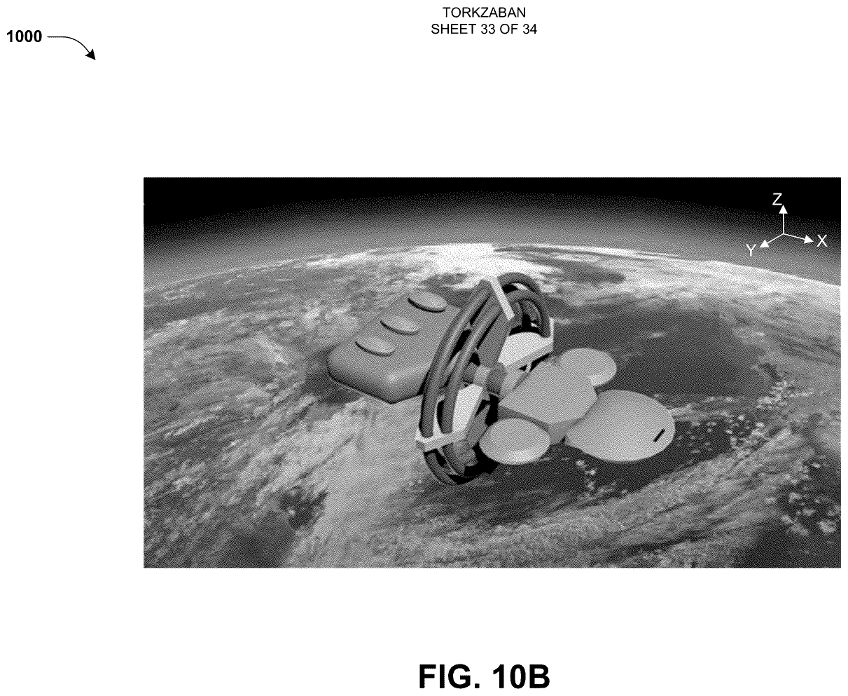

FIGS. 10A-10B illustrate an air-space bus 1000, according to some embodiments, the air-space bus 1000 comprises a plurality of linear motion generation apparatuses. In some examples, the air-space bus 1000 may be utilized to carry passengers and/or cargos in the air and/or space.

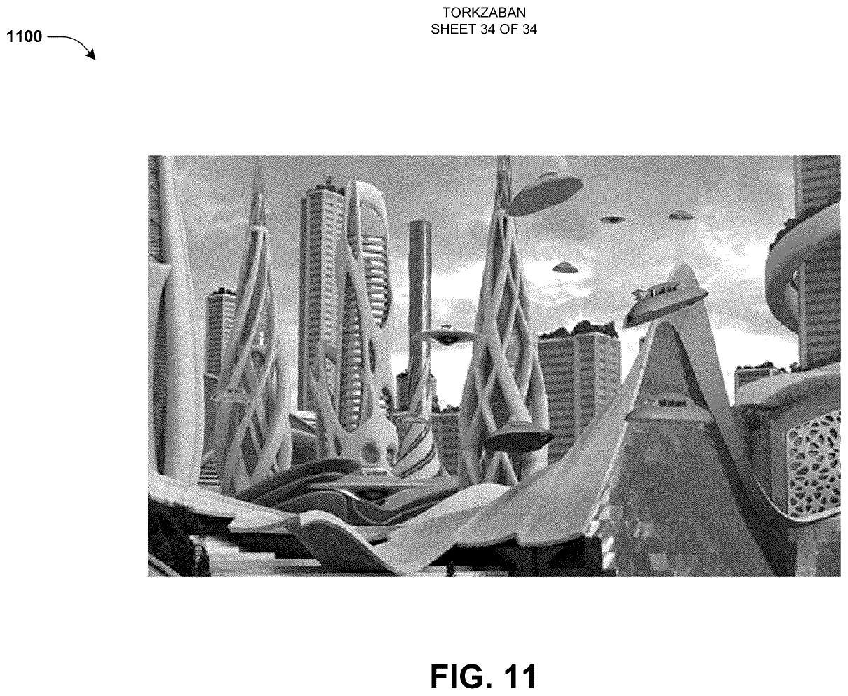

FIG. 11 illustrates an image 1100 of a city with aerial vehicles equipped with linear motion generation apparatuses, according to some embodiments.

In some examples, the linear motion generation apparatus 100 may be utilized to transport passengers and/or cargos in at least one of (i) road transportation, (ii) air transportation, (iii) maritime transportation (e.g., water transportation), and/or (iv) space transportation. In some examples, the linear motion generation apparatus 100 may be used for various types of travelling (e.g., high speed travelling) such as ground travelling, maritime transportation, air travelling and/or space travelling.

In some examples, using an electric motor and/or a battery as a power supplier for the power generation unit 102, the linear motion generation apparatus 100 may be utilized in air and/or space transportation without air pollution and/or space pollution.

In some examples, the linear motion generation apparatus 100 may be used in submarines. In some examples, the linear motion generation apparatus 100 used in submarines does not need to use propellers in order to move on water and/or under water.

In some examples, the linear motion generation apparatus 100 may utilize a nuclear reactor in order to generate power for the power generation unit 102. In some examples, the linear motion generation apparatus 100 may be used in long-distance travelling vehicles (e.g., air vehicles and/or space vehicles).

In some examples, the linear motion generation apparatus 100 may be used in personal transportations and/or public transportations instead of a car, a bus, an airplane, a train and etc.

In some examples, the linear motion generation apparatus 100 may implement a closed liquid system for generating linear motion. For example, the closed liquid system may be inside of (and/or implemented using) a plurality of hollow arms (e.g., at least one of the first set of hollow arms 113, the second set of hollow arms 115, etc.). A rotation of the plurality of hollow arms may cause movement of one or more fluids inside the plurality of hollow arms. The movement of the one or more fluids inside the plurality of hollow arms may increase weight of one or more first hollow arms of the plurality of hollow arms and/or decreases weight of one or more second hollow arms of the plurality of hollow arms. The weight increase and/or the weight decrease convert a centrifugal force into a linear force.

Some advantages of using the linear motion generation apparatus 100 in transportation may include (i) faster and safer travel in the air, which does not require a driver even, (ii) easy to be controlled automatically, (iii) it does not need a vacuum or air movement to move in the air and is independent, so it does not have a propeller and engine like existing aircrafts and requires less space, (iv) silent, (v) no air pollution (or less than a threshold amount of air pollution), (vi) no need (or less need) for an airport and/or spaceport, (vii) easily charged with home electricity, (viii) able to carry heavy loads, (ix) able to move backwards at high speed and stay suspended, (x) able to change direction in any direction with high speed, and/or (xi) increased efficiency (and/or increased angular velocity of rotating arms) and/or a reduced amount of noise pollution as compared to some systems that attempt to convert centrifugal force to linear force.

According to some embodiments, a linear motion generation apparatus is provided. The linear motion generation apparatus includes a power generation unit connected to a first shaft, wherein the first shaft allows a first hollow arm to rotate about a first rotation axis and a linear motion generation device, the linear motion generation device includes a first cell. The first cell includes a first set of plates and the first hollow arm. The first hollow arm is connected to the first shaft. The first hollow arm includes one or more first metal covers connected to one or more first wheels. The one or more first metal covers define a first arm chamber and the one or more first wheels are in contact with the first set of plates. The first hollow arm includes one or more first isolation layers inside the first arm chamber. The one or more first isolation layers define a first fluid chamber to house a first fluid.

According to some embodiments, the first hollow arm is connected to the first shaft coaxially.

According to some embodiments, the power generation unit includes an electromotor configured to rotate the first shaft.

According to some embodiments, the first shaft rotates manually.

According to some embodiments, the first set of plates include a first plate and a second plate. The first hollow arm is between the first plate and the second plate.

According to some embodiments, one or more wheels of the one or more first wheels are in contact with a first surface of the first plate, the first surface is tapered to have a first slope, one or more wheels of the one or more first wheels are in contact with a second surface of the second plate and/or the second surface is tapered to have a second slope.

According to some embodiments, the first slope is opposite in polarity to the second slope.

According to some embodiments, the linear motion generation device includes: a second cell comprising: a second set of plates; and a second hollow arm, wherein the second hollow arm is connected to a second shaft and includes: one or more second metal covers connected to one or more second wheels, wherein the one or more second metal covers define a second arm chamber and the one or more second wheels are in contact with the second set of plates; and one or more second isolation layers inside the second arm chamber, wherein the one or more second isolation layers define a second fluid chamber to house a second fluid.

According to some embodiments, the linear motion generation apparatus includes a gearbox, wherein the gearbox allows the first shaft to rotate about the first rotation axis and the second shaft to rotate about a second rotation axis.

According to some embodiments, the first shaft allows the first hollow arm to rotate about the first rotation axis with a first angular velocity, and the second shaft allows the second hollow arm to rotate about the second rotation axis with a second angular velocity.

According to some embodiments, a first direction of rotation of the first hollow arm is opposite to a second direction of rotation of the second hollow arm.

According to some embodiments, the linear motion generation device includes a first hydraulic jack connected to the first set of plates and the second set of plates, one or more first gears connected to the first set of plates and/or one or more second gears connected to the second set of plates. The first hydraulic jack allows the first set of plates to rotate about a first set of rotation axes and/or the first hydraulic jack allows the second set of plates to rotate about a second set of rotation axes.

According to some embodiments, the second hollow arm is connected to the second shaft coaxially.

According to some embodiments, the second set of plates include a first plate and a second plate, and the second hollow arm is between the first plate and the second plate.

According to some embodiments, one or more wheels of the one or more second wheels are in contact with a first surface of the third plate, the first surface is tapered to have a third slope, one or more wheels of the one or more second wheels are in contact with a second surface of the fourth plate and/or the second surface is tapered to have a fourth slope.

According to some embodiments, the first slope is opposite in polarity to the second slope.

According to some embodiments, the first fluid includes a metal and/or the second fluid includes a metal.

According to some embodiments, the first fluid includes ethylene dibromide (EDB); Cis-1,2-Dibromoethene; Trans-1,2-Dibromoethene; Dibromomethane; Bromal; Bromoform; 1,1,2,2-Tetrabromoethane (Muthmanns solution); Sodium polytungstate; Bromine; Thoulets solution; Diiodomethane; Indium (III) iodide; Barium tetraiodomercurate (II); Thallium formate+thallium malonate (Clerici solution); Galinstan (gallium, indium, tin alloy) and/or Mercury and/or the second fluid includes ethylene dibromide (EDB); Cis-1,2-Dibromoethene; Trans-1,2-Dibromoethene; Dibromomethane; Bromal; Bromoform; 1,1,2,2-Tetrabromoethane (Muthmanns solution); Sodium polytungstate; Bromine; Thoulets solution; Diiodomethane; Indium (III) iodide; Barium tetraiodomercurate (II); Thallium formate+thallium malonate (Clerici solution); Galinstan (gallium, indium, tin alloy) and/or Mercury.

According to some embodiments, the linear motion generation device includes a chassis configured to protect the first cell, the second cell, the first shaft and/or the second shaft.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments and/or examples are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment and/or example provided herein. Also, it will be understood that not all operations are necessary in some embodiments and/or examples.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A linear motion generation apparatus, comprising:
a power generation unit connected to a first shaft, wherein the first shaft allows a first hollow arm to rotate about a first rotation axis; and
a linear motion generation device, comprising:
a first cell, comprising:
a first set of plates; and
the first hollow arm, wherein the first hollow arm is connected to the first shaft and comprises:
one or more first metal covers connected to one or more first wheels, wherein the one or more first metal covers define a first arm chamber and the one or more first wheels are in contact with the first set of plates; and
one or more first isolation layers inside the first arm chamber, wherein the one or more first isolation layers define a first fluid chamber to house a first fluid.

2. The linear motion generation apparatus of claim 1, wherein the first hollow arm is connected to the first shaft coaxially.

3. The linear motion generation apparatus of claim 1, wherein the power generation unit comprises an electromotor configured to rotate the first shaft.

4. The linear motion generation apparatus of claim 1, wherein the first shaft rotates manually.

5. The linear motion generation apparatus of claim 1, wherein:
the first set of plates comprise a first plate and a second plate; and
the first hollow arm is between the first plate and the second plate.

6. The linear motion generation apparatus of claim 5, wherein at least one of:
one or more wheels of the one or more first wheels are in contact with a first surface of the first plate;
the first surface is tapered to have a first slope;
one or more wheels of the one or more first wheels are in contact with a second surface of the second plate; or
the second surface is tapered to have a second slope.

7. The linear motion generation apparatus of claim 6, wherein:
the first slope is opposite in polarity to the second slope.

8. The linear motion generation apparatus of claim 1, wherein the linear motion generation device comprises:
a second cell comprising:
a second set of plates; and
a second hollow arm, wherein the second hollow arm is connected to a second shaft and comprises:
one or more second metal covers connected to one or more second wheels, wherein the one or more second metal covers define a second arm chamber and the one or more second wheels are in contact with the second set of plates; and
one or more second isolation layers inside the second arm chamber, wherein the one or more second isolation layers define a second fluid chamber to house a second fluid.

9. The linear motion generation apparatus of claim 8, comprising:
a gearbox, wherein the gearbox allows the first shaft to rotate about the first rotation axis and the second shaft to rotate about a second rotation axis.

10. The linear motion generation apparatus of claim 9, wherein:
the first shaft allows the first hollow arm to rotate about the first rotation axis with a first angular velocity; and
the second shaft allows the second hollow arm to rotate about the second rotation axis with a second angular velocity.

11. The linear motion generation apparatus of claim 9, wherein a first direction of rotation of the first hollow arm is opposite to a second direction of rotation of the second hollow arm.

12. The linear motion generation apparatus of claim 8, wherein the linear motion generation device comprises at least one of:
a first hydraulic jack connected to the first set of plates and the second set of plates, wherein at least one of:
the first hydraulic jack allows the first set of plates to rotate about a first set of rotation axes; or
the first hydraulic jack allows the second set of plates to rotate about a second set of rotation axes;
one or more first gears connected to the first set of plates; or
one or more second gears connected to the second set of plates.

13. The linear motion generation apparatus of claim 8, wherein the second hollow arm is connected to the second shaft coaxially.

14. The linear motion generation apparatus of claim 8, wherein:
the second set of plates comprise a first plate and a second plate; and
the second hollow arm is between the first plate and the second plate.

15. The linear motion generation apparatus of claim 14, wherein at least one of:
one or more wheels of the one or more second wheels are in contact with a first surface of the third plate;
the first surface is tapered to have a third slope;
one or more wheels of the one or more second wheels are in contact with a second surface of the fourth plate; or
the second surface is tapered to have a fourth slope.

16. The linear motion generation apparatus of claim 15, wherein:
the first slope is opposite in polarity to the second slope.

17. The linear motion generation apparatus of claim 8, wherein at least one of:
the first fluid comprises a metal; or
the second fluid comprises a metal.

18. The linear motion generation apparatus of claim 8, wherein at least one of:
the first fluid comprises at least one of:
ethylene dibromide (EDB);
Cis-1,2-Dibromoethene;
Trans-1,2-Dibromoethene;
Dibromomethane;
Bromal;
Bromoform;
1,1,2,2-Tetrabromoethane (Muthmanns solution);
Sodium polytungstate;
Bromine;
Thoulets solution;
Diiodomethane;
Indium (III) iodide;
Barium tetraiodomercurate (II);
Thallium formate+thallium malonate (Clerici solution);
Galinstan (gallium, indium, tin alloy); or
Mercury; or
the second fluid comprises at least one of:
ethylene dibromide (EDB);
Cis-1,2-Dibromoethene;
Trans-1,2-Dibromoethene;
Dibromomethane;
Bromal;
Bromoform;
1,1,2,2-Tetrabromoethane (Muthmanns solution);
Sodium polytungstate;
Bromine;
Thoulets solution;
Diiodomethane;
Indium (III) iodide;
Barium tetraiodomercurate (II);
Thallium formate+thallium malonate (Clerici solution);
Galinstan (gallium, indium, tin alloy); or
Mercury.

19. A linear motion generation apparatus, comprising:
a power generation unit connected to a first shaft, wherein the first shaft allows a first hollow arm to rotate about a first rotation axis; and
a linear motion generation device, comprising:
a first cell, comprising:
a first set of plates; and
the first hollow arm, wherein the first hollow arm is connected to the first shaft and comprises:
one or more first metal covers connected to one or more first wheels, wherein the one or more first metal covers define a first arm chamber and the one or more first wheels are in contact with the first set of plates; and
one or more first isolation layers inside the first arm chamber, wherein the one or more first isolation layers define a first fluid chamber to house a first fluid; and
a chassis configured to protect at least one of the first cell or the first shaft.

20. The linear motion generation apparatus of claim 19, wherein the first hollow arm is connected to the first shaft coaxially.
